(19) United States
(12) Patent Application Publication
(10) Pub. No.: US 2025/0317905 A1
(43) Pub. Date: Oct. 9, 2025

(54) CELL RADIO NETWORK TEMPORARY IDENTIFERS FOR EARLY DATA TRANSMISSION COMMUNICATIONS

(71) Applicant: QUALCOMM Incorporated, San Diego, CA (US)

(72) Inventors: Bharat SHRESTHA, San Diego, CA (US); Alberto RICO ALVARINO, San Diego, CA (US); Ayan SENGUPTA, San Diego, CA (US); Harikumar KRISHNAMURTHY, San Diego, CA (US); Syed Hashim Ali SHAH, San Diego, CA (US)

(21) Appl. No.: 18/627,286

(22) Filed: Apr. 4, 2024

(51) Int. Cl. H04W 72/04

(52) U.S. Cl. CPC H04W 72/04

(57) ABSTRACT

Various aspects of the present disclosure generally relate to wireless communication. In some aspects, a user equipment (UE) may transmit an early data transmission (EDT) communication. The UE may receive a response communication that indicates: a successful content resolution of the EDT communication, and a UE-specific C-RNTI. Numerous other aspects are described.

### FIELD OF THE DISCLOSURE

Aspects of the present disclosure generally relate to wireless communication and specifically relate to techniques, apparatuses, and methods for cell radio network temporary identifiers for early data transmission communications.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include transmitting an early data transmission (EDT) communication. The method may include receiving a response communication that indicates, a successful content resolution of the EDT communication, and a UE-specific cell radio network temporary identifier (C-RNTI).

Some aspects described herein relate to a method of wireless communication performed by a UE. The method may include transmitting an EDT communication. The method may include receiving a response communication that is addressed to a multicast C-RNTI, the multicast C-RNTI comprising: a temporary C-RNTI, a configured RNTI, or an RNTI derived from the uplink transmission occasion of EDT, the response communication indicating, an unsuccessful content resolution of the EDT communication, and to continue monitoring a downlink communication channel using the multicast C-RNTI.

Some aspects described herein relate to a method of wireless communication performed by a network node. The method may include receiving a first EDT communication from a first UE and a second EDT communication from a second UE. The method may include transmitting, based at least in part on decoding the first EDT, a first response communication that is directed to the first UE and indicates, a successful content resolution of the first EDT communication, and a UE-specific C-RNTI that is assigned to the first UE.

Some aspects described herein relate to an apparatus configured for wireless communications. The apparatus may include one or more memories including processor-executable instructions and one or more processors configured to execute the processor-executable instructions. The one or more processors may be configured to cause the apparatus to transmit an EDT communication. The one or more processors may be configured to cause the apparatus to receive a response communication that indicates, a successful content resolution of the EDT communication, and a UE-specific C-RNTI.

Some aspects described herein relate to an apparatus configured for wireless communications. The apparatus may include one or more memories including processor-executable instructions and one or more processors configured to execute the processor-executable instructions. The one or more processors may be configured to cause the apparatus to transmit an EDT communication. The one or more processors may be configured to cause the apparatus to receive a response communication that is addressed to a multicast C-RNTI, the multicast C-RNTI comprising: a temporary C-RNTI, a configured RNTI, or an RNTI derived from the uplink transmission occasion of EDT, the response communication indicating, an unsuccessful content resolution of the EDT communication, and an indication to continue monitoring a downlink communication channel using the multicast C-RNTI.

Some aspects described herein relate to an apparatus configured for wireless communications. The apparatus may include one or more memories including processor-executable instructions and one or more processors configured to execute the processor-executable instructions. The one or more processors may be configured to cause the apparatus to receive a first EDT communication from a first UE and a second EDT communication from a second UE. The one or more processors may be configured to cause the apparatus to transmit, based at least in part on decoding the first EDT, a first response communication that is directed to the first UE and indicates, a successful content resolution of the first EDT communication, and a UE-specific C-RNTI that is assigned to the first UE.

Some aspects described herein relate to a non-transitory computer-readable medium that stores a set of instructions for wireless communication by a UE. The set of instructions, when executed by one or more processors of the UE, may cause the UE to transmit an EDT communication. The set of instructions, when executed by one or more processors of the UE, may cause the UE to receive a response communication that indicates, a successful content resolution of the EDT communication, and a UE-specific C-RNTI.

Some aspects described herein relate to a non-transitory computer-readable medium that stores a set of instructions for wireless communication by a one or more instructions that, when executed by one or more processors of a UE. The set of instructions, when executed by one or more processors of the UE, may cause the UE to transmit an EDT communication. The set of instructions, when executed by one or more processors of the UE, may cause the UE to receive a response communication that is addressed to a multicast C-RNTI, the multicast C-RNTI comprising: a temporary C-RNTI, a configured RNTI, or an RNTI derived from the uplink transmission occasion of EDT, the response communication indicating, an unsuccessful content resolution of the EDT communication, and an indication to continue monitoring a downlink communication channel using the multicast C-RNTI.

Some aspects described herein relate to a non-transitory computer-readable medium that stores a set of instructions for wireless communication by a network node. The set of instructions, when executed by one or more processors of the network node, may cause the network node to receive a first EDT communication from a first UE and a second EDT communication from a second UE. The set of instructions, when executed by one or more processors of the network node, may cause the network node to transmit, based at least in part on decoding the first EDT, a first response communication that is directed to the first UE and indicates, a successful content resolution of the first EDT communication, and a UE-specific C-RNTI that is assigned to the first UE.

Some aspects described herein relate to an apparatus for wireless communication. The apparatus may include means for transmitting an EDT communication. The apparatus may include means for receiving a response communication that indicates, a successful content resolution of the EDT communication, and a UE-specific C-RNTI.

Some aspects described herein relate to an apparatus for wireless communication. The apparatus may include means for transmitting an EDT communication. The apparatus may include means for receiving a response communication that is addressed to a multicast C-RNTI, the multicast C-RNTI comprising: a temporary C-RNTI, a configured RNTI, or an RNTI derived from the uplink transmission occasion of EDT, the response communication indicating, an unsuccessful content resolution of the EDT communication, and an indication to continue monitoring a downlink communication channel using the multicast C-RNTI.

Some aspects described herein relate to an apparatus for wireless communication. The apparatus may include means for receiving a first EDT communication from a first UE and a second EDT communication from a second UE. The apparatus may include means for transmitting, based at least in part on decoding the first EDT, a first response communication that is directed to the first UE and indicates, a successful content resolution of the first EDT communication, and a UE-specific C-RNTI that is assigned to the first UE.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of small data transmission types, in accordance with the present disclosure.

FIG. 5 is a diagram illustrating an example of a four-step random access procedure, in accordance with the present disclosure.

FIGS. 6A, 6B, and 6C are diagram illustrating a first example, a second example, and a third example, respectively, of an early data transmission process, in accordance with the present disclosure.

FIG. 7 is a diagram illustrating an example of a wireless communication process between a network node and a UE, in accordance with the present disclosure.

FIG. 8 is a diagram illustrating an example of a wireless communication process between a network node and a UE, in accordance with the present disclosure.

FIG. 9 is a flowchart of an example method of wireless communication, in accordance with the present disclosure.

FIG. 10 is a flowchart of an example method of wireless communication, in accordance with the present disclosure.

FIG. 11 is a flowchart of an example method of wireless communication, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

FIG. 14 is a diagram illustrating an example of an implementation of code and circuitry for a communications device, in accordance with the present disclosure.

FIG. 15 is a diagram illustrating an example of an implementation of code and circuitry for a communications device, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Small data transmission (SDT) is a procedure that allows a user equipment (UE) to transmit data and/or signaling while remaining in inactive state and/or without establishing a connection. One example of an SDT is an early data transmission (EDT). A UE may transmit an EDT using at least part of a random access channel (RACH) procedure, as described below. To illustrate, a network node may provide the UE with multiple physical uplink shared channel (PUSCH) resources, and, as part of a physical random access channel (PRACH) selection procedure for transmitting an EDT communication (e.g., an EDT and/or an EDT request), the UE may select a particular PUSCH resource to use for transmitting the EDT communication. In some aspects, the UE may randomly select the PUSCH resource from the multiple PUSCH resources. Based at least in part on receiving the EDT communication, a network node may transmit a downlink communication that is a response communication to the EDT communication. The network node may address the downlink communication using a multicast cell radio network temporary identifier (C-RNTI), such as a temporary C-RNTI, a common C-RNTI, a configured RNTI, and/or an RNTI that is derived from an uplink transmission occasion of an EDT, that may be used by multiple UEs.

In an EDT scenario, a UE associated with the EDT communication may use the multicast C-RNTI as an assigned C-RNTI. The UE using the multicast C-RNTI as an assigned C-RNTI may result in conflicts in scenarios that include multiple UEs, as described below. Alternatively, or additionally, the conflicts may result in communication failures in a wireless network.

Various aspects relate generally to a UE-specific C-RNTI in an EDT response communication. Some aspects more specifically relate to a network node transmitting a UE-specific C-RNTI in a downlink communication that is addressed using a multicast C-RNTI, and a UE using the UE-specific C-RNTI instead of the multicast C-RNTI. A UE may transmit an EDT communication. For example, the UE may transmit the EDT communication as part of a RACH procedure and/or a RACH-less procedure. The UE may receive a response communication (e.g., an EDT response communication) that indicates a successful content resolution of the EDT communication, and includes a UE-specific C-RNTI. In some aspects, the response communication may be addressed to a multicast C-RNTI, and the UE-specific C-RNTI may be different from the multicast C-RNTI. In some aspects, the UE may use the UE-specific C-RNTI to communicate in a wireless network.

In some aspects, a UE may transmit an EDT communication. Based at least in part on transmitting the EDT communication, the UE may receive a response communication that is addressed to a multicast C-RNTI (e.g., a temporary C-RNTI, a configured RNTI, or an RNTI derived from the uplink transmission occasion of EDT). In some aspects, the response communication may indicate an unsuccessful content resolution of the EDT communication, and may include an indication to continue monitoring a downlink channel using the multicast C-RNTI. In some examples, the response communication may include a retransmission grant that is associated with retransmitting the EDT communication.

In some aspects, a network node may receive a first EDT communication from a first UE and a second EDT communication from a second UE. Based at least in part on successfully decoding the first EDT, the network node may transmit a first response communication that is directed to the first UE. The first response communication may indicate a successful content resolution of the first EDT communication and a UE-specific C-RNTI that is assigned to the first UE. In some aspects, the first response communication may be addressed to a multicast C-RNTI, and the UE-specific C-RNTI may be different from the multicast C-RNTI.

Particular aspects of the subject matter described in this disclosure can be implemented to realize one or more of the following potential advantages. In some examples, by indicating a UE-specific C-RNTI in a downlink communication that is addressed to a multicast C-RNTI, the described techniques can be used to enable a network node to mitigate C-RNTI collisions. Mitigating C-RNTI collisions may result in mitigating communication failures at one or more UEs.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

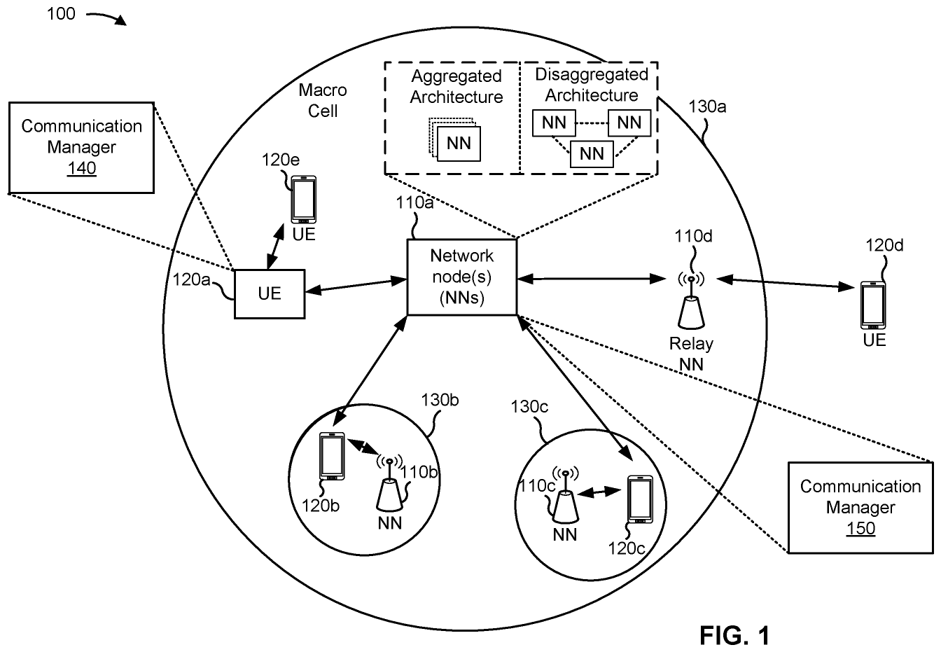

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, PRACH extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more PUSCHs. The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally, or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay May receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally, or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100 and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., a UE 120) may include a communication manager 140. As described in more detail elsewhere herein, the communication manager 140 may transmit an EDT communication; and receive a response communication that indicates: a successful content resolution of the EDT communication, and a UE-specific C-RNTI.

In some aspects, the communication manager 140 may transmit an EDT communication; and receive a response communication that is addressed to a multicast C-RNTI, the multicast C-RNTI comprising: a temporary C-RNTI, a configured RNTI, or an RNTI derived from the uplink transmission occasion of EDT, the response communication indicating: an unsuccessful content resolution of the EDT communication, and to continue monitoring a downlink communication channel using the multicast C-RNTI. Additionally, or alternatively, the communication manager 140 may perform one or more other operations described herein.

In some aspects, a network node (e.g., a network node 110) may include a communication manager 150. As described in more detail elsewhere herein, the communication manager 150 may receive a first EDT communication from a first UE and a second EDT communication from a second UE; and transmit, based at least in part on decoding the first EDT, a first response communication that is directed to the first UE and indicates: a successful content resolution of the first EDT communication, and a UE-specific C-RNTI that is assigned to the first UE. Additionally, or alternatively, the communication manager 150 may perform one or more other operations described herein.

As indicated above, FIG. 1 is provided as an example. Other examples may differ from what is described with regard to FIG. 1.

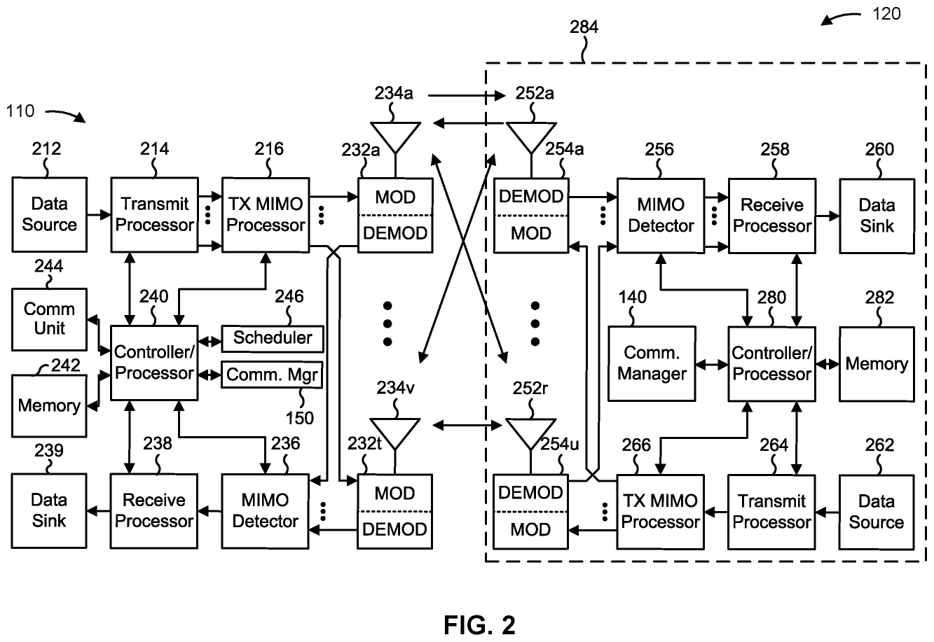

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP 26econd26err, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

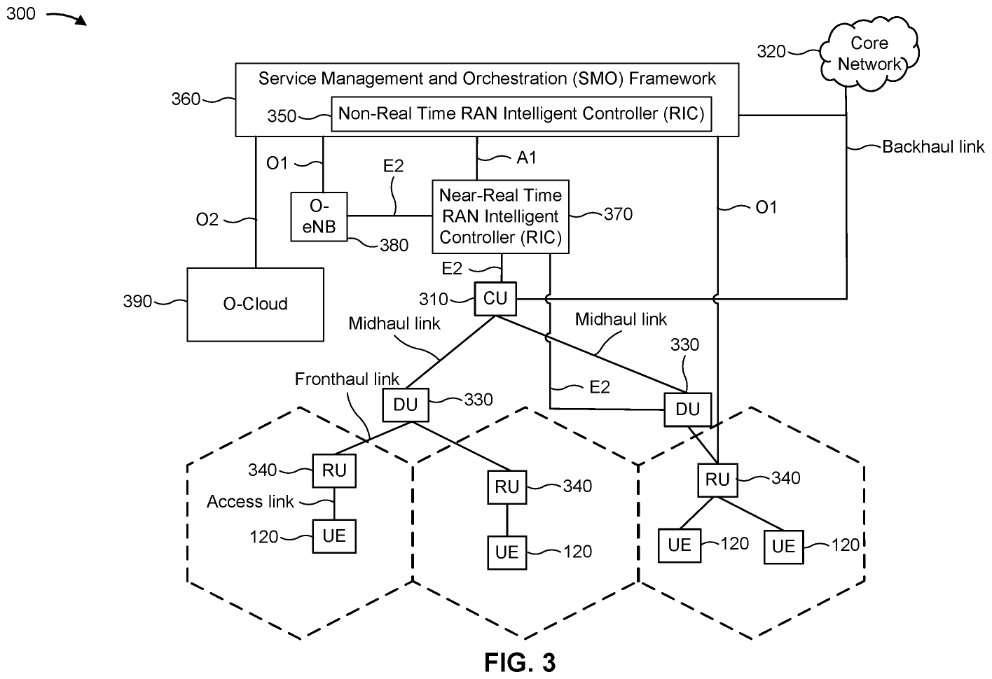

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

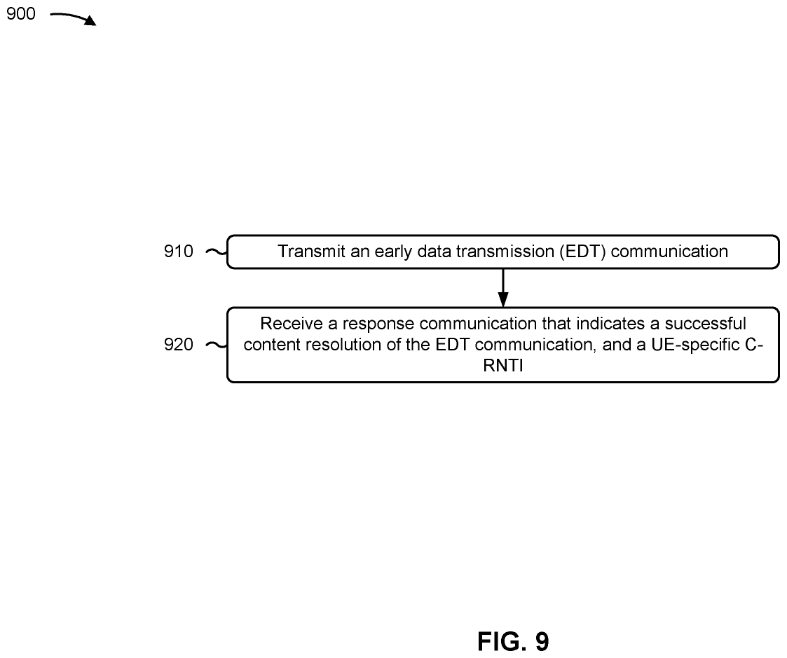

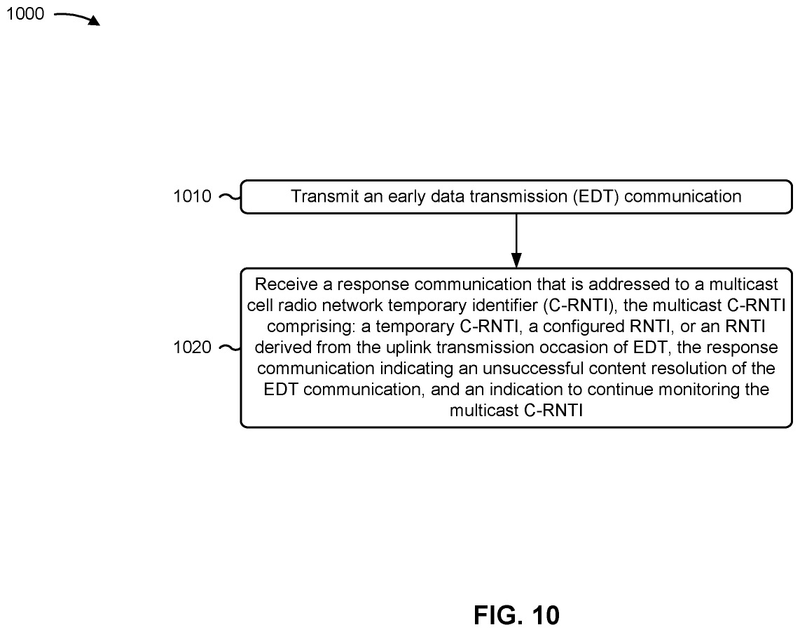

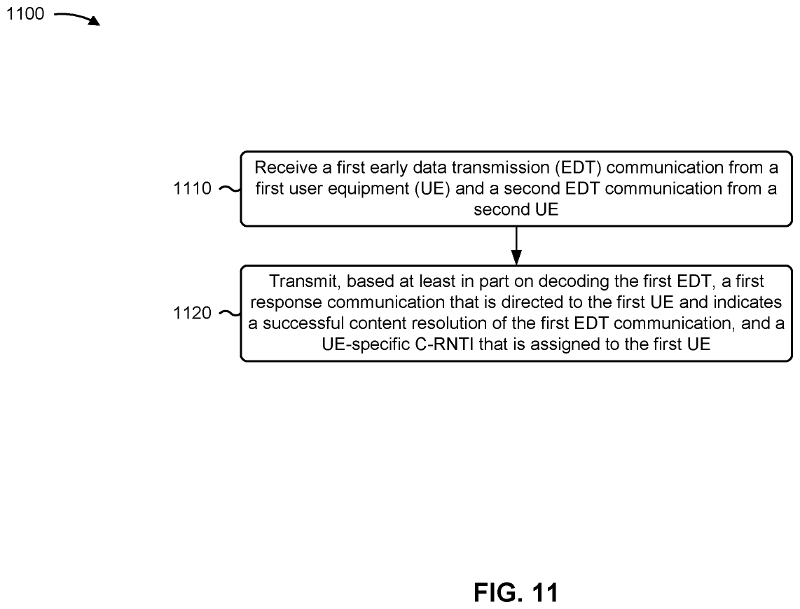

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with C-RNTIs for EDT communications, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, method 900 of FIG. 9, method 1000 of FIG. 10, method 1100 of FIG. 11 or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform method 900 of FIG. 9, method 1000 of FIG. 10, method 1100 of FIG. 11, or other processes as described herein. In some examples, executing instructions may include running the instructions, converting the instructions, compiling the instructions, and/or interpreting the instructions, among other examples.

In some aspects, a UE (e.g., a UE 120) includes means for transmitting an EDT communication; and/or means for receiving a response communication that indicates: a successful content resolution of the EDT communication, and a UE-specific C-RNTI.

Alternatively, or additionally, the UE includes means for transmitting an EDT communication; and/or means for receiving a response communication that is addressed to a multicast C-RNTI, the multicast C-RNTI comprising: a temporary C-RNTI, a configured RNTI, or an RNTI derived from the uplink transmission occasion of EDT, the response communication indicating: an unsuccessful content resolution of the EDT communication, and to continue monitoring a downlink communication channel using the multicast C-RNTI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., a network node 110) includes means for receiving a first EDT communication from a first UE and a second EDT communication from a second UE; and/or means for transmitting, based at least in part on decoding the first EDT, a first response communication that is directed to the first UE and indicates: a successful content resolution of the first EDT communication, and a UE-specific C-RNTI that is assigned to the first UE. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

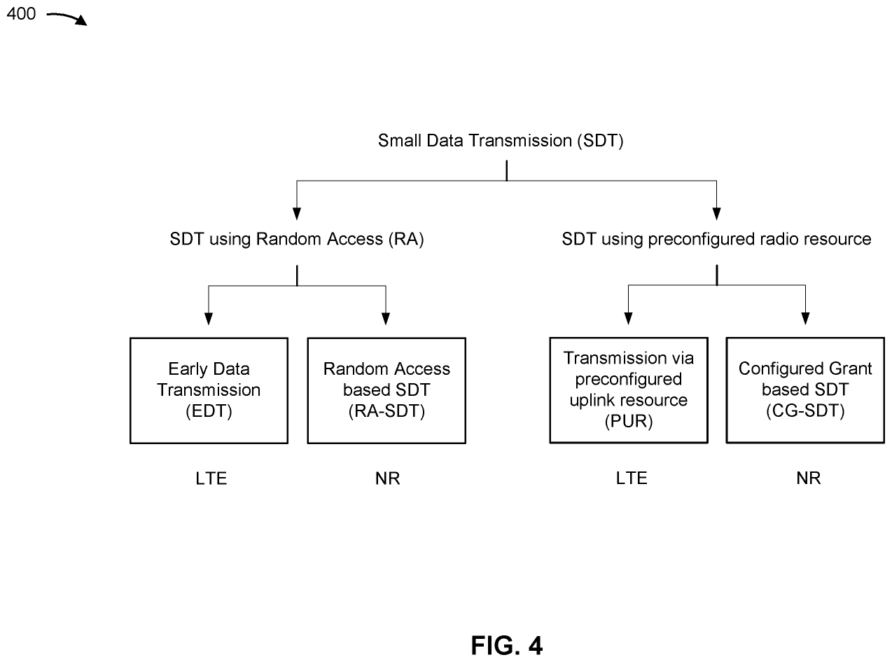

FIG. 4 is a diagram illustrating an example 400 of SDT types, in accordance with the present disclosure.

SDT is a procedure that allows a UE to transmit data and/or signaling while remaining in an NR RRC inactive state (LTE idle state), without transitioning to an RRC active state and/or RRC connected state (establishing a connection). The UE is able to conserve power and signaling resources by using low latency, low overhead, and power-efficient SDTs while avoiding the additional signaling that is involved with entering a connected mode.

There are different types of SDT. As shown by example 400, for NR, SDT may include RACH SDT, or random access (RA) SDT (RA-SDT). RA-SDT May include 2-step RA-SDT and 4-step RA-SDT. SDT for NR may also include CG-SDT for a contention free scenario. For LTE (eMTC and narrowband-IoT), SDT may include EDT during RA (for 4-step RACH). SDT for LTE may also include a preamble uplink resource (PUR) for a contention free scenario. CG-SDT for NR is comparable to PUR for LTE. 4-step RA-SDT for NR is comparable to EDT for LTE.

There are some other differences between SDT for NR and SDT for LTE. SDT for NR may involve a normal uplink carrier and a supplemental uplink carrier, while SDT for LTE may involve only the normal uplink carrier. SDT for NR may involve multiple subsequent data transmissions, while SDT for LTE may involve only one uplink data transmission and/or one downlink data transmission. SDT for NR may involve a signaling radio bearer and a data radio bearer, while SDT for LTE may involve only a data radio bearer. SDT for NR may involve a non-anchor relocation base station and an anchor relocation base station, while SDT for LTE may involve only an anchor relocation base station.

As indicated above, FIG. 4 is provided as an example. Other examples may differ from what is described with regard to FIG. 4.

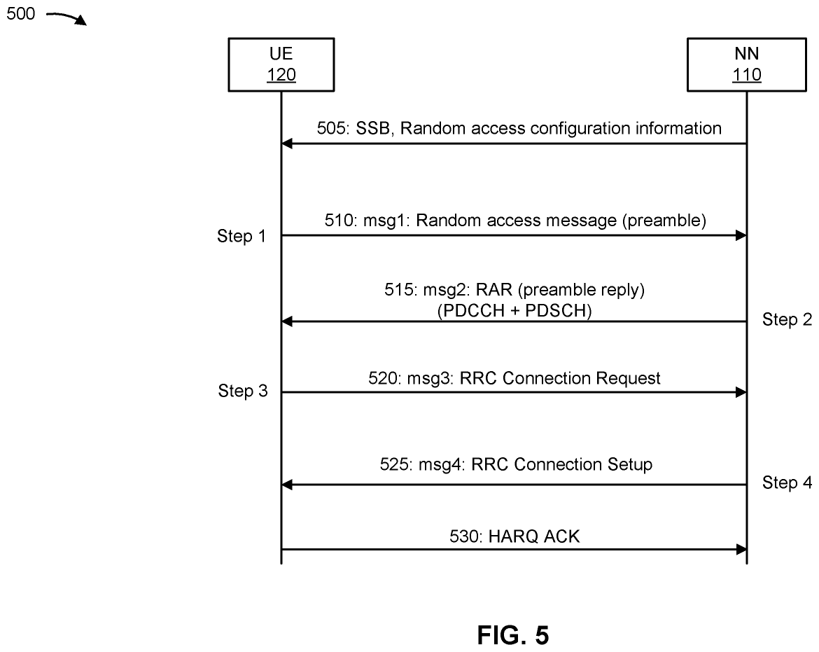

FIG. 5 is a diagram illustrating an example 500 of a four-step random access procedure, in accordance with the present disclosure. As shown in FIG. 5, a network node 110 and a UE 120 may communicate with one another to perform the four-step random access procedure.

As shown by reference number 505, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a physical PDCCH order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 510, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 515, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. As part of the second step of the four-step random access procedure, the network node 110 may also transmit the PDSCH communication for the RAR, as scheduled by the PDCCH communication. The RAR may be included in a MAC protocol data unit (PDU) of the PDSCH communication.

As shown by reference number 520, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request).

As shown by reference number 525, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 530, if the UE 120 successfully receives the RRC connection setup message, the UE 120 may transmit a HARQ ACK.

In some aspects, the UE 120 may perform at least some of the steps included in the example 500 based at least in part on operating in an RRC idle state and/or an RRC inactive state. For instance, the UE 120 may transmit msg1 as described with regard to reference number 510 while operating in the RRC idle state, receive msg2 as described with regard to reference number 515 while operating in the RRC idle state, and/or transmit msg3 as described with regard to reference number 520 while operating in the RRC idle state. As described with regard to FIG. 4, the UE 120 may transmit an EDT communication in the msg3.

Alternatively, or additionally, at least some of the steps described with regard to the example 500 may be used and/or included in a two-step RACH procedure. As one example, and as part of a two-step RACH procedure UE 120 may transmit, and the network node 110 may receive, a msgA that includes at least portions of the msg1 and/or the msg3 described with regard to the four-step RACH procedure. In some aspects, and as part of the two-step RACH procedure, the network node 110 may transmit, and the UE 120 may receive, a msgB that includes at least portions of the msg2 and/or the msg 4.

As indicated above, FIG. 5 is provided as an example. Other examples may differ from what is described with regard to FIG. 5.

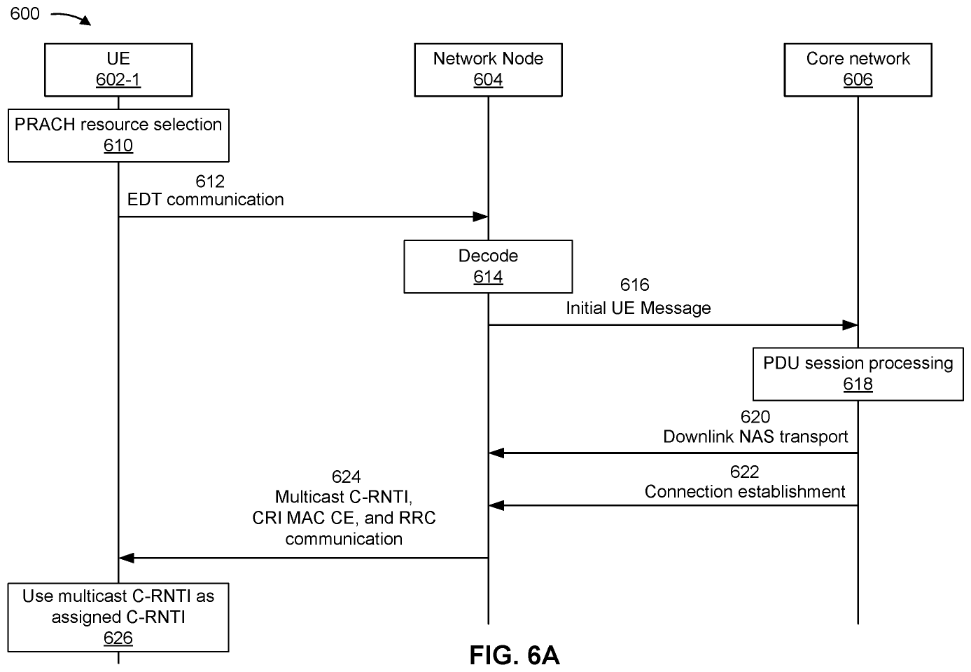

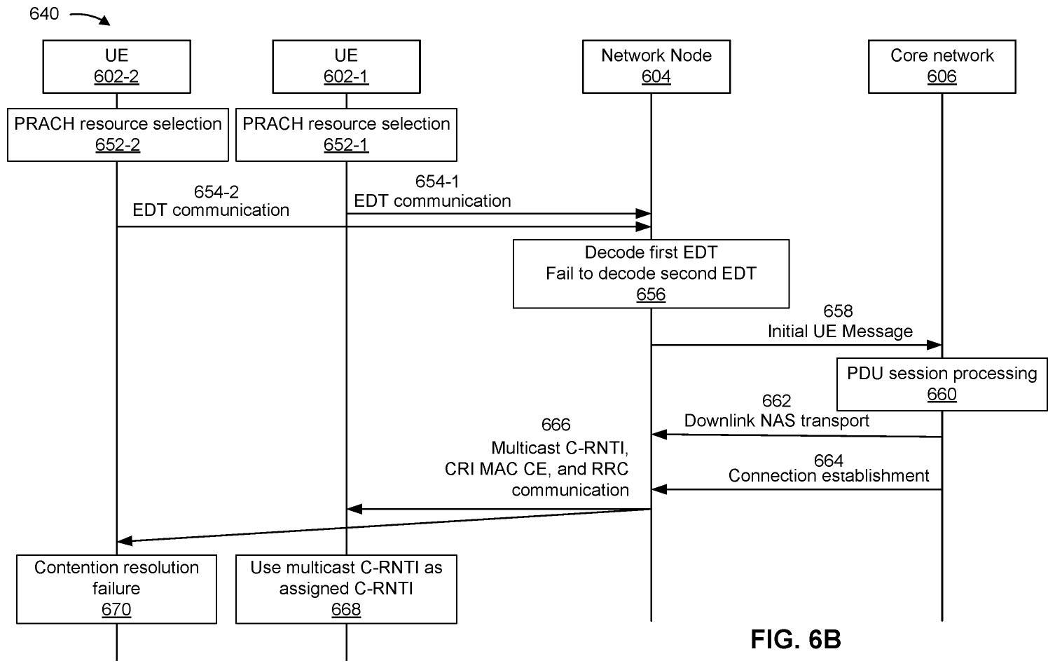

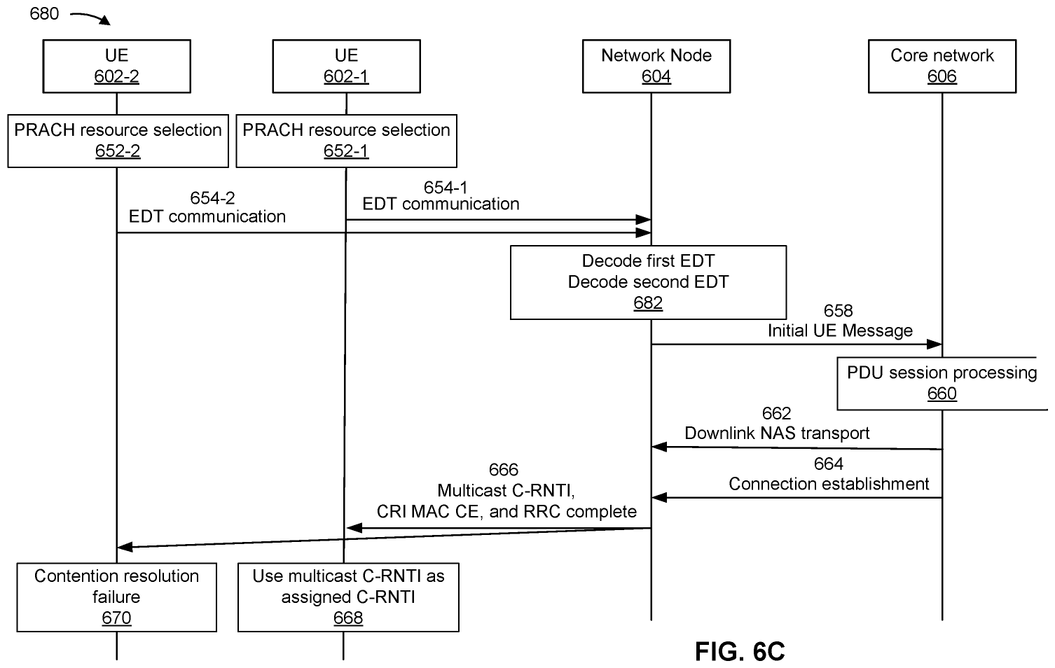

FIGS. 6A, 6B, and 6C are diagram illustrating a first example 600, a second example 640, and a third example 680, respectively, of an early data transmission process, in accordance with the present disclosure. The first example 600 that is shown by FIG. 6A includes a first UE 602-1, a network node 604 (e.g., a network node 110), and a core network 606. The second example 640 that is shown by FIG. 6B includes the first UE 602-1, a second UE 602-2, the network node 604, and the core network 606. The third example 680 that is shown by FIG. 6C includes the first UE 602-1, the second UE 602-2, the network node 604, and the core network node 606. In some aspects, the core network 606 may include one or more core network devices and may provide any combination of mobility management, serving gateway functionality, user plane functionality, access and mobility functionality, and/or session management functionality.

As shown by reference number 610 in FIG. 6A, the first UE 602-1 may perform a PRACH selection procedure using multiple PUSCH resources. To illustrate, the multiple PUSCH resources may be provided to the first UE 602-1 (and/or multiple UEs as described with regard to FIG. 6B) by a network node 110, and, as part of a PRACH selection procedure, the first UE 602-1 may select a particular PUSCH resource to use for transmitting an EDT communication (e.g., an EDT and/or an EDT request). In some aspects, the first UE 602-1 may randomly select the PUSCH resource from the multiple PUSCH resources. In some aspects, the first UE 602-1 may perform the PRACH selection procedure while operating in an RRC idle state.

As part of an EDT, the first UE 602-1 may not receive a preamble and/or an RAR from the network node 604 in a similar manner as described with regard to FIG. 5. For example, as part of a RACH-less procedure, the first UE 602-1 may not transmit a msg1 as described with regard to reference number 510 and/or the network node 604 may not transmit a msg2 as described with regard to reference number 515. Accordingly, the first UE 602-1 may transmit uplink data and/or the EDT request without using a preamble and/or without receiving an RAR from the network node 604.

As shown by reference number 612, the first UE 602-1 may transmit, and the network node 604 may receive, an EDT communication (e.g., an EDT and/or an EDT request). In some aspects, the first UE 602-1 may transmit the EDT communication as part of a RACH procedure, such as a four-step RACH procedure and/or a two-step RACH procedure as described with regard to FIG. 5. For instance, the first UE 602-1 may transmit the EDT communication in a msg3 of a four-step RACH procedure and/or a msgA of a two-step RACH procedure. In some aspects, the first UE 602-1 may transmit the EDT communication in a msg3 and/or msgA using the PUSCH resource that was selected from the multiple PUSCH resources. The first UE 602-1 may include a content resolution identifier (ID) in the EDT communication that may be used by the network node 604 to associate the EDT communication with the first UE 602-1.

As shown by reference number 614, the network node 604 may decode the EDT request. In decoding the EDT communication, the network node 604 may identify that the communication is from the first UE 602-1 and/or that the communication is an EDT communication.

As shown by reference number 616, the network node 604 may transmit, and the core network 606 may receive, a next generation access protocol (NG-AP) message and/or a non-access stratum (NAS) message that indicates an initial UE message that is associated with the first UE 602-1 attempting to connect to the network. In some aspects, the initial UE message may include any combination of an identity of the first UE 602-1, a capability of the first UE 602-1, timing information about the first UE 602-1, a service requested by the first UE 602-1, and/or initial radio parameters associated with the first UE 602-1 (e.g., transmission power level).

As shown by reference number 618, the core network 606 may perform PDU session processing for the first UE 602-1. For instance, the core network 606 may establish a PDU session for the first UE 602-1. Alternatively, or additionally, the core network 606 may obtain user data that is directed to the first UE 602-1.

As shown by reference number 620, the core network 606 may transmit, and the network node 604 may receive, a downlink NAS transport communication that is associated with the first UE 602-1. In some aspects, the downlink NAS transport communication may include control signaling (e.g., mobility management signaling, session management signaling, and/or session management signaling) for establishing a PDU session with the first UE 602-1.

As shown by reference number 622, the core network 606 may transmit, and the network node 604 may receive, a connection establishment communication that is associated with the first UE 602-1. In some aspects, the connection establishment communication may confirm that a PDU session has been established by the core network 606 for the first UE 602-1.

As shown by reference number 624, the network node 604 may transmit, and the first UE 602-1 may receive, a downlink communication (e.g., a msg4 and/or a msgB, as described with regard to FIG. 5), and the downlink communication may be addressed to a multicast C-RNTI (e.g., a temporary C-RNTI, a common C-RNTI, a configured RNTI, and/or an RNTI that is derived from an uplink transmission occasion of an EDT). In some aspects, the downlink communication may include a contention resolution identity (CRI) MAC CE to indicate whether a transmission contention occurred (e.g., a failure to decode based at least in part on a communication collision) and/or whether the transmission contention was resolved successfully or unsuccessfully. Alternatively, or additionally, the downlink communication may include an RRC communication, such as an RRC setup message, that is directed to the first UE 602-1. The RRC communication may direct the first UE 602-1 to transition from the RRC idle state to an RRC active state and/or RRC connected state. In some aspects, the downlink communication described with regard to reference number 624 may be alternatively referred to as an EDT response communication (e.g., a response to the EDT communication by the first UE 602-1).

The downlink communication may include an identifier that indicates the downlink communication is directed to the first UE 602-1. As one example, the downlink communication may include the content resolution ID included in the EDT communication transmitted by the first UE 602-1. In some aspects, the multicast C-RNTI may be associated with multicast and/or groupcast messaging. That is, the multicast C-RNTI may a temporary C-RNTI, a common C-RNTI, a configured RNTI, and/or an RNTI that is derived from an uplink transmission occasion of an EDT, and the multicast C-RNTI may be associated with communicating with each UE in a multicast group of UEs and/or a groupcast group of UEs.

As shown by reference number 626, the first UE 602-1 may use the multicast C-RNTI (e.g., a temporary C-RNTI, a common C-RNTI, a configured RNTI, and/or an RNTI that is derived from an uplink transmission occasion of an EDT) as an assigned C-RNTI. That is, the first UE 602-1 and/or the network node 604 may use the multicast C-RNTI to identify and/or address communications to and/or from the first UE 602-1. The use of a multicast C-RNTI as an assigned C-RNTI may result in conflicts in scenarios that includes multiple UEs. Alternatively, or additionally, the conflicts may result in communication failures in a wireless network.

To illustrate, the second example 640 shown by FIG. 6B includes the first UE 602-1, the second UE 602-2, the network node 604, and the core network 606 as described above. For simplicity, the example 640 includes two UEs, but other examples may include more UEs that perform commensurate operations as described above and below. In some aspects, the first UE 602-1 and the second UE 602-1 may begin the example 640 in an RRC idle state.

As shown by reference number 652-1, the first UE 602-1 may perform a PRACH selection procedure in a similar manner as described with regard to reference number 610. Alternatively, or additionally, and as shown by reference number 652-2, the second UE 602-1 may perform a PRACH selection procedure in a similar manner as described with regard to reference number 610. In some aspects, the first UE 602-1 and the second UE 602-2 may select a same resource. To illustrate, and in a similar manner as described above, multiple PUSCH resources may be provided to the first UE 602-1 for a first uplink transmission (e.g., a first EDT communication), and, as part of a PRACH selection procedure, the first UE 602-1 may select a particular PUSCH resource to use for the uplink transmission. The same multiple PUSCH resources may be provided to the second UE 602-2 for a second uplink transmission (e.g., a second EDT communication), and, as part of a PRACH selection procedure, the second UE 602-2 may select the same particular PUSCH resource as the first UE 602-1.

As shown by reference number 654-1, the first UE 602-1 may transmit, and the network node 604 may receive, a first uplink communication that indicates a first EDT communication in a similar manner as described with regard to reference number 612. For instance, the first UE 602-1 may include a first content resolution ID in the first uplink communication. Alternatively, or additionally, and as shown by reference number 654-2, the second UE 602-2 may transmit, and the network node 604 may receive, a second uplink communication that indicates a second EDT communication in a similar manner as described with regard to reference number 612. For instance, the second UE 602-2 may include a second content resolution ID in the second uplink communication. In some aspects, the first UE 602-1 may transmit the first uplink communication using the PUSCH resource that was selected from the multiple PUSCH resources, and the second UE 602-2 may transmit the second uplink communication using the same PUSCH resource as the first UE 602-1.

The first EDT communication transmitted by the first UE 602-1 may have a same (e.g., within a threshold value) transmit power level as the second EDT communication transmitted by the second UE 602-2, or may have a different transmit power level than the second EDT communication. Alternatively, or additionally, the first EDT communication transmitted by the first UE 602-1 may have a same number of TBs as the second EDT communication transmitted by the second UE 602-1, or may have a different number of TBs than the second EDT communication. In some aspects, the first uplink communication may have a same number and/or a different number of repetitions relative to the second uplink communications. Variations in any combination of transmit power levels, number of TBs, and/or number of repetitions may be used in some scenarios to mitigate a frequency collision between the first uplink communication and a second uplink communication. That is, the variations in transmit power levels, number of TBs, and/or repetitions may be used to reduce recovery errors.

As shown by reference number 656, the network node 604 may successfully decode the first uplink communication and/or identify that the first uplink communication indicates the first EDT communication. Alternatively, or additionally, the network node 604 may identify that the first EDT communication is from the first UE 602-1. As also shown by reference number 656, the network node 604 may fail to decode the second uplink communication. For example, based at least in part on the first uplink communication and the second uplink communication sharing a same PUSCH resource, the second uplink communication received by the network node 604 may include enough interference (e.g., due to a frequency collision with the first uplink communication) that results in a decoding failure at the network node 604.

As shown by reference number 658, the network node 604 may transmit, and a core network 606 may receive, an NG-AP message and/or a NAS message that indicates an initial UE message that is associated with the first UE 602-1 attempting to connect to the network in a similar manner as described with regard to reference number 616. As shown by reference number 660, the core network 606 may perform PDU session processing for the first UE 602-1 in a similar manner as described with regard to reference number 618. As shown by reference number 662, the core network 606 may transmit, and the network node 604 may receive, a downlink NAS transport communication that is associated with the first UE 602-1 in a similar manner as described with regard to reference number 620. As shown by reference number 664, the core network 606 may transmit, and the network node 604 may receive, a connection establishment communication that is associated with the first UE 602-1 in a similar manner as described with regard to reference number 622.

As shown by reference number 666, the network node 604 may transmit, and the first UE 602-1 and/or the second UE 606-2 may receive, a downlink communication that indicates a multicast C-RNTI (e.g., a temporary C-RNTI, a common C-RNTI, a configured RNTI, and/or an RNTI that is derived from an uplink transmission occasion of an EDT) in a similar manner as described with regard to reference number 624. In some aspects, the downlink communication may be a multicast downlink communication that may be received and/or decoded by multiple UEs. The downlink communication may alternatively, or additionally, include a CRI MAC CE and/or an RRC setup message that is directed to the first UE 602-1.

In some aspects, the downlink communication may be transmitted as a multicast and/or groupcast message that is directed to the first UE 602-1. For instance, the network node 604 may include the first content resolution ID in the downlink communication to direct the downlink communication to the first UE 602-1. In some aspects, the downlink communication described with regard to reference number 666 may be alternatively referred to as an EDT response communication (e.g., a response to the EDT communication transmitted by the first UE 602-1).

As shown by reference number 668, the first UE 602-1 may use the multicast C-RNTI as an assigned C-RNTI in a similar manner as described with regard to reference number 626. To illustrate, the first UE 602-1 may analyze the downlink communication and identify that the downlink communication includes the first content resolution ID. Accordingly, the first UE 602-1 may derive that the downlink communication is directed to the first UE 602-1. Alternatively, or additionally, the first UE 602-1 may analyze the CRI MAC CE and identify that the first uplink communication was successfully decoded by the network node 604. In some aspects, the first UE 602-1 may transition to an RRC active state and/or RRC connected state as directed by an RRC communication included in the downlink communication (e.g., an RRC setup message). Based at least in part on determining that the first uplink communication was successfully decoded and/or transitioning to the RRC active state and/or RRC connected state, the first UE 602-1 may use the multicast C-RNTI to identify to communicate in the wireless network. However, the first UE 602-1 using the multicast C-RNTI as an assigned C-RNTI may result in communication failures at the second UE 602-2.

For example, and as shown by reference number 670, the second UE 602-2 may initiate a content resolution failure procedure. To illustrate, the second UE 602-2 may receive the multicast downlink communication transmitted by the network node 604 as described with regard to reference number 666, and the second UE 602-2 may identify that a content resolution ID in the multicast downlink communication does not match the second content resolution ID transmitted by the second UE 602-2 in the second uplink communication. Accordingly, the second UE 606-2 may initiate a content resolution failure procedure.

Accordingly, in the second example 640, the network node 604 may transmit a CRI MAC CE and/or RRC communication (e.g., a first EDT response communication) to one UE (e.g., the first UE 602-1) via a multicast downlink communication, but may be unable to provide a retransmission grant (e.g., a second EDT response communication that is based at least in part on failing to decode the second EDT communication) to a second UE (e.g., the second UE 602-1) for a retransmission of the EDT communication based at least in part on the first UE 602-1 using the multicast C-RNTI as an assigned C-RNTI. To illustrate, if the network node 604 transmitted a second downlink communication using the multi C-RNTI to transmit a retransmission grant to the second UE 602-1, the first UE 606-1 may derive that the second downlink communication is directed to the first UE 606-1, resulting in a C-RNTI collision and, consequently, failed communications at the first UE 602-1 and/or the second UE 602-2.

The third example 680 that is shown by FIG. 6C provides an alternative scenario to the second example 640 that is shown by FIG. 6B. To illustrate, as shown by reference number 652-1, the first UE 602-1 may perform a PRACH selection procedure, and, as shown by reference number 652-2, the second UE 602-1 may perform a PRACH selection procedure, each in a similar manner as described with regard to reference number 610. As shown by reference number 654-1, the first UE 602-1 may transmit, and the network node 604 may receive, a first uplink communication that indicates a first EDT communication, and, as shown by reference number 654-2, the second UE 602-2 may transmit, and the network node 604 may receive, a second uplink communication that indicates a second EDT communication, each in a similar manner as described with regard to reference number 612.

As shown by reference number 682, the network node 604 may successfully decode the first uplink communication from the first UE 602-1 and may successfully decode the second uplink communication from the second UE 606-2. To illustrate, the first uplink communication transmitted by the first UE 602-1 may vary from the second uplink communication transmitted by the second UE 606-2, such as by using a different transmit power level, a different number of TBs, and/or a different number of repetitions, and the variation(s) may be configured and/or selected to mitigate a frequency collision between the first uplink. That is, the variations may enable the network node to successfully decode both the first uplink communication and the second uplink communication (e.g., with a number of recovery errors that satisfy an error threshold). Accordingly, and based at least in part on recovering both the first EDT in the first uplink communication and the second EDT in the second uplink communication, the network node 604 may begin a respective procedure for each UE to transition each UE from an RRC idle state to an RRC active state and/or RRC connected state.

Accordingly, as part of transitioning the first UE 602-1 to the RRC active state and/or RRC connected state and as shown by reference number 658, the network node 604 may transmit, and a core network 606 may receive, an NG-AP message and/or a NAS message that indicates an initial UE message that is associated with the first UE 602-1 attempting to connect to the network in a similar manner as described with regard to reference number 616. As shown by reference number 660, the core network 606 may perform PDU session processing for the first UE 602-1 in a similar manner as described with regard to reference number 618. As shown by reference number 662, the core network 606 may transmit, and the network node 604 may receive, a downlink NAS transport communication that is associated with the first UE 602-1 in a similar manner as described with regard to reference number 620. As shown by reference number 664, the core network 606 may transmit, and the network node 604 may receive, a connection establishment communication that is associated with the first UE 602-1 in a similar manner as described with regard to reference number 622.

For clarity, the example 680 does not include the network node 604 performing commensurate exchanges with the core network 606 as part of transitioning the second UE 606-2 to the RRC active state and/or RRC connected state. However, other examples may include the network node 604 and/or the core network 606 performing any combination of actions as described with regard to reference number 658, reference 660, reference number 662, and/or reference number 664 with information associated with the second UE 606-2. Alternatively, or additionally, the network node 604 and/or the core network node 606 may append information associated with the second UE 606-2 to communications that are associated with the first UE 606-1.

As shown by reference number 666, the network node 604 may transmit, and the first UE 602-1 and/or the second UE 606-2 may receive, a downlink communication that indicates a multicast C-RNTI (e.g., a temporary C-RNTI, a common C-RNTI, a configured RNTI, and/or an RNTI that is derived from an uplink transmission occasion of an EDT) in a similar manner as described with regard to reference number 624. In some aspects, the downlink communication described with regard to reference number 666 may be alternatively referred to as an EDT response communication (e.g., a response to the EDT communication transmitted by the first UE 602-1). As shown by reference number 668, the first UE 602-1 may use the multicast C-RNTI as an assigned C-RNTI in a similar manner as described with regard to reference number 626.

Alternatively, or additionally, and as shown by reference number 670, the second UE 602-2 may initiate a content resolution failure procedure. To illustrate, and as described above, the second UE 602-2 may receive the multicast downlink communication transmitted by the network node 604 as described with regard to reference number 666, and the second UE 602-2 may identify that a content resolution ID in the multicast downlink communication does not match the second content resolution ID transmitted by the second UE 602-2 in the second uplink communication, resulting in the second UE 606-2 performing a content resolution procedure.

In the example 680, the network node 604 may be able to transmit a first CRI MAC CE and/or a first RRC communication (e.g., a first EDT response communication) to transition one UE (e.g., the first UE 602-1) to the RRC active state and/or RRC connected state, but may be unable to transmit a second CRI MAC CE and/or a second RRC communication to transition a second UE (e.g., the second UE 602-1) to the RRC active state and/or RRC connected state based at least in part on the first UE 602-1 using the multicast C-RNTI as an assigned C-RNTI. To illustrate, and in a similar manner as described above, if the network node 604 transmitted a second downlink communication (e.g., a second EDT response communication) using the multicast C-RNTI to transmit a second CRI MAC CE and/or a second RRC communication to transition the second UE 602-1 to the RRC connected state, the first UE may derive that the second downlink communication is directed to the first UE 606-1, resulting in a C-RNTI collision and, consequently, failed communications at the first UE 602-1 and/or the second UE 602-2.

Some techniques and apparatuses described herein provide a UE-specific C-RNTI in an EDT response communication. In some aspects, a UE (e.g., a UE 120) may transmit an EDT communication. For example, the UE may transmit the EDT communication as part of a RACH procedure (e.g., using a msg3 and/or a msgA) and/or a RACH-less procedure (e.g., that omits msg1 and msg2). The UE may receive a response communication (e.g., an EDT response communication) that indicates a successful content resolution of the EDT communication, and a UE-specific C-RNTI. In some aspects, the response communication may be addressed to a multicast C-RNTI (e.g., a temporary C-RNTI, a common C-RNTI, a configured RNTI, and/or an RNTI that is derived from an uplink transmission occasion of an EDT), and the UE-specific C-RNTI may be different from the multicast C-RNTI. In some aspects, the UE may use the UE-specific C-RNTI to communicate in a wireless network.

In some aspects, a UE may transmit an EDT communication. Based at least in part on transmitting the EDT communication, the UE may receive a response communication that is addressed to a multicast C-RNTI, the multicast C-RNTI comprising: a temporary C-RNTI, a configured RNTI, or an RNTI derived from the uplink transmission occasion of EDT. In some aspects, the response communication may indicate an unsuccessful content resolution of the EDT communication, and may include to continue monitoring a downlink communication channel using the multicast C-RNTI. For some examples, the response communication may include a retransmission grant that is associated with retransmitting the EDT communication.

In some aspects, a network node may receive a first EDT communication from a first UE and a second EDT communication from a second UE. Based at least in part on successfully decoding the first EDT, the network node may transmit a first response communication that is directed to the first UE. The first response communication may indicate a successful content resolution of the first EDT communication and a UE-specific C-RNTI that is assigned to the first UE. In some aspects, the first response communication may be addressed to a multicast C-RNTI (e.g., a temporary C-RNTI and/or a common C-RNTI), and the UE-specific C-RNTI may be different from the multicast C-RNTI.

By indicating a UE-specific C-RNTI in a downlink communication that is addressed to a multicast C-RNTI, a network node may mitigate C-RNTI collisions, such as in the second example described with regard to FIG. 6B and the third example described with regard to FIG. 6C. Mitigating C-RNTI collisions may result in mitigating communication failures at one or more UEs.

As indicated above, FIGS. 6A, 6B, and 6C are provided as examples. Other examples may differ from what is described with regard to Fig. FIGS. 6A, 6B, and 6C.

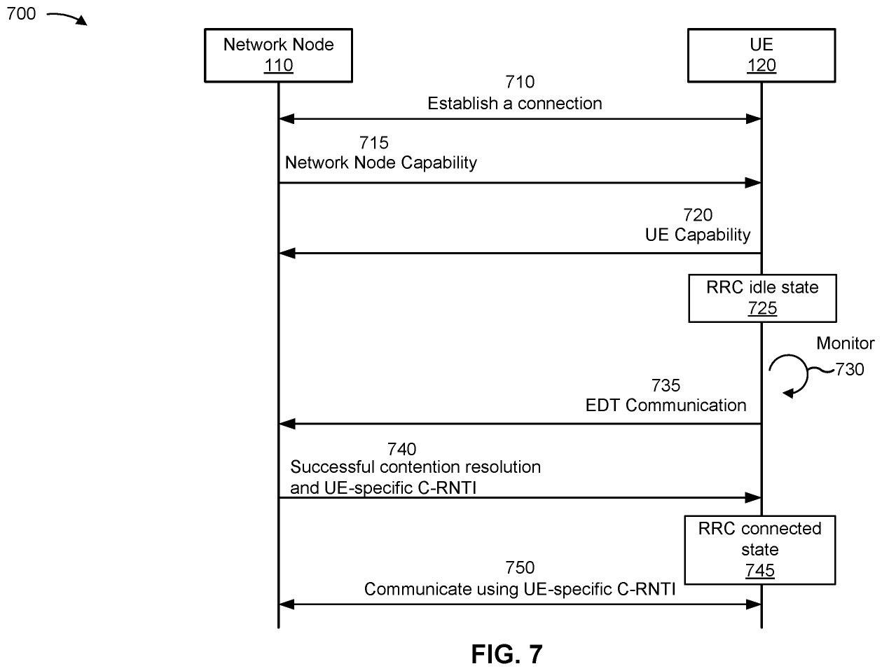

FIG. 7 is a diagram illustrating an example 700 of a wireless communication process between a network node (e.g., a network node 110) and a UE (e.g., a UE 120), in accordance with the present disclosure.

As shown by reference number 710, the network node 110 and the UE 120 may establish a connection. To illustrate, the UE 120 may power up in a cell coverage area provided by the network node 110, and the UE 120 and the network node 110 may perform one or more procedures (e.g., a RACH procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., DCI and/or UCI), Layer 2 signaling (e.g., a MAC CE), and/or Layer 3 signaling (e.g., RRC signaling). To illustrate, the network node 110 may request, via RRC signaling, UE capability information, and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE being tolerant of communication delays, and the network node 110 may transmit an activation of the configuration via Layer 2 signaling and/or Layer 1 signaling at a second point in time associated with the UE being intolerant to communication delays.

In some aspects, and as part of establishing a connection with the UE 120, the network node 110 may communicate multiple PUSCH resources that may be used for an EDT communication. Alternatively, or additionally, the network node 110 may communicate a multicast C-RNTI to the UE 120 to use for monitoring for a multicast downlink communication.

As shown by reference number 715, the network node 110 may transmit, and the UE 120 may receive, an indication of a network node capability. For clarity, FIG. 7 shows the network node 110 transmitting the network node capability separately from establishing a connection with the UE 120, but in some examples, the network node 110 may transmit the indication of the network node capability as at least part of establishing a connection with the UE 120.

In some aspects, the network node capability may indicate and/or specify that the network node 110 includes support for UE-specific C-RNTI assignment for EDT. That is, the network node 110 may indicate support for, and/or ability to, assign a UE-specific C-RNTI to a UE in an EDT response communication. The network node 110 may indicate support for UE-Specific C-RNTI assignment for EDT in a SIB, and the UE 120 may receive the SIB as part of establishing a connection with the network node 110 and/or after establishing the connection with the network. However, in other examples, the network node 110 may indicate support for UE-specific C-RNTI assignment for EDT in any combination of Layer 1 signaling, Layer 2 signaling and/or Layer 3 signaling.

As shown by reference number 720, the UE 120 may transmit, and the network node 110 may receive, a UE capability indication. For clarity, FIG. 7 shows the UE 120 transmitting the UE capability indication separately from establishing a connection with the network node 110, but in some examples, UE 120 may transmit the indication of the UE capability as at least part of establishing a connection with the network node 110. In some aspects, the UE 120 may transmit the UE capability indication that specifies support for the UE-specific C-RNTI assignment for EDT in an RRC message, a MAC sub-header, and/or a logical channel identifier (LCID) codepoint. The UE 120 may transmit the UE capability indication based at least in part on receiving a query for UE capability information (e.g., from the network node 110).

Alternatively, or additionally, the UE 120 may transmit the UE capability indication that specifies the support for the UE-specific C-RNTI assignment for EDT based at least in part on receiving the network node capability indication. To illustrate, the UE 120 may include an indication of support for the UE-specific C-RNTI assignment for EDT in the UE capability information based at least in part on receiving a SIB that indicates the network node 110 supports UE-specific C-RNTI assignment for EDT and/or may omit the indication of support for the UE-specific C-RNTI assignment for EDT based at least in part on the SIB not indicating that the network node 110 supports UE-specific C-RNTI assignment for EDT.

In some aspects, the UE 120 may transmit the indication of support for a UE-specific C-RNTI assignment for EDT prior to transmitting an EDT communication. However, in other aspects, the UE 120 may transmit the indication of support for the UE-specific C-RNTI assignment for EDT during an EDT communication, in an EDT communication, and/or in a transmission that carries the EDT communication. Transmitting the indication of support for a UE-specific C-RNTI assignment for EDT may enable the network node 110 to assign a UE-specific C-RNTI to the UE 120 as further described below and mitigate C-RNTI collisions.

As shown by reference number 725, the UE 120 may transition to an RRC idle state. As one example, an inactivity timer at the UE 120 may expire, resulting in the UE 120 transitioning to the RRC idle state. As another example, the network node 110 may transmit an instruction to transition to the RRC idle state that results in the UE 120 transitioning to the RRC idle state. In some aspects, as part of the instruction to transition to the RRC idle state, the network node 110 may indicate multiple PUSCH resources to the UE 120 (e.g., PUSCH resources that may be used for an EDT communication) and/or a multicast C-RNTI to use for monitoring for a multicast downlink communication.

As shown by reference number 730, the UE 120 may monitor a downlink channel, such as a PDCCH, using a multicast C-RNTI (e.g., a temporary C-RNTI, a common C-RNTI, a configured RNTI, and/or an RNTI that is derived from an uplink transmission occasion of an EDT) that is shared with at least one other UE. As described above, the network node 110 may indicate the C-RNTI to the UE 120.

As shown by reference number 735, the UE 120 may transmit, and the network node 110 may receive, an EDT communication (e.g., an EDT and/or an EDT request). As described with regard to FIGS. 6A, 6B, and 6C, the UE 120 may select a PUSCH resource (e.g., from multiple PUSCH resources) to use for transmitting the EDT communication. In some aspects, the EDT communication may be transmitted based at least in part on a RACH-less procedure (e.g., without msg1 and msg2). Alternatively, or additionally, the UE 120 may transmit the EDT communication as at least part of a RACH procedure, such as a four-step RACH procedure and/or a two-step RACH procedure. To illustrate, the UE 120 may transmit the EDT communication in a msg3 of a four-step RACH procedure and/or a msgA of a two-step RACH procedure.

In some aspects, the UE 120 may transmit the EDT communication using a same PUSCH resource as another UE 120 and/or using a same RACH preamble as another UE 120. Alternatively, or additionally, the UE 120 may include, in the EDT communication, a content resolution ID.

As shown by reference number 740, the network node 110 may transmit, and the UE 120 may receive a downlink communication that indicates a successful contention resolution of the EDT communication (e.g., successful decoding). Alternatively, or additionally, the downlink communication may indicate a UE-specific C-RNTI that is assigned to the UE 120. The network node 110 may transmit the downlink communication and/or indicate the UE-specific C-RNTI in any combination of an RRC communication, a MAC CE, and/or DCI.

As one example, the network node 110 may indicate the UE-specific C-RNTI in the RRC communication, such as an RRC setup communication. As another example, the network node 110 may indicate the UE-specific C-RNTI in an RRC release message or an RRC early data complete message. In some examples, the RRC release message and/or the RRC early data complete message may include a NAS PDU, but in other examples, the RRC release message and/or the RRC early data complete message does not include a NAS PDU. As yet another example, the network node may indicate a UE-specific C-RNTI in an RRC resume message.

In some aspects, the network node 110 may transmit the UE-specific C-RNTI (e.g., assigned to the UE 120) in a RACH communication. For example, the network node 110 may transmit the UE-specific C-RNTI in a msg4 of a four-step RACH procedure and/or in a msgB of a two-step RACH procedure. However, the network node 110 may alternatively, or additionally, transmit the UE-specific C-RNTI in a RACH-less procedure.

In some aspects, the downlink communication (e.g., the response communication to the EDT) that indicates the successful content resolution of the EDT communication (e.g., successful decoding) and the UE-specific C-RNTI may be addressed to a multicast C-RNTI. That is, the network node 110 may transmit the downlink communication as a multicast downlink communication that is addressed to a multicast C-RNTI (e.g., a temporary C-RNTI, a configured RNTI, or an RNTI derived from the uplink transmission occasion of EDT).

The network node 110 may indicate the UE-specific C-RNTI as an absolute C-RNTI (e.g., a C-RNTI that does not need altering by the UE 120). However, in other examples, the network node 110 may indicate the UE-specific C-RNTI as a delta C-RNTI that is based at least in part on the multicast C-RNTI used to address the downlink communication and/or the response communication. Accordingly, the UE 120 may derive a UE-specific C-RNTI that is assigned to the UE 120 using the delta C-RNTI and the multicast C-RNTI, such as by combining the delta C-RNTI and the multicast C-RNTI.

As shown by reference number 745, the UE 120 may transition to an RRC connected state and/or an RRC active state. To illustrate, the downlink communication and/or the response communication described with regard to reference number 740 may include an RRC setup message or an RRC resume message, resulting in the UE 120 transitioning to an RRC connected mode.

In some aspects, and as described with regard to reference number 730, the UE 120 may monitor, prior to receiving the downlink communication and/or the response communication that indicates the successful content resolution, a downlink channel (e.g., the PDCCH) using the multicast C-RNTI. Based at least in part on receiving a downlink communication and/or a response communication that indicates successful content resolution of the EDT communication transmitted as described with regard to reference number 735, the UE 120 may discard the multicast C-RNTI and/or may cease using the multicast C-RNTI for downlink channel monitoring (e.g., PDCCH monitoring).

As shown by reference number 750, the UE 120 and the network node 110 may communicate with one another in a wireless network using the UE-specific C-RNTI. That is, the UE 120 and the network node 110 may communicate with one another using the UE-specific C-RNTI and based at least in part on the successful content resolution of the EDT communication as described with regard to reference number 745. As one example, the network node 110 may transmit a downlink communication that uses and/or is addressed to the UE-specific C-RNTI, and the UE 120 may receive and/or recover the downlink communication based at least in part on identifying the UE-specific C-RNTI in the downlink communication.

By indicating a UE-specific C-RNTI in a downlink communication that is addressed to a multicast C-RNTI, a network node may mitigate C-RNTI collisions. For instance, and as described with regard to the example 700, the network node may assign a UE-specific C-RNTI to a UE that is associated with an EDT with a successful content resolution by the network node 110. The network node may use the UE-specific C-RNTI to communicate with the UE, and may reuse the multicast C-RNTI to communicate with other UEs without a C-RNTI collision. Mitigating C-RNTI collisions may result in mitigating communication failures at one or more UEs.

As indicated above, FIG. 7 is provided as an example. Other examples may differ from what is described with regard to FIG. 7.

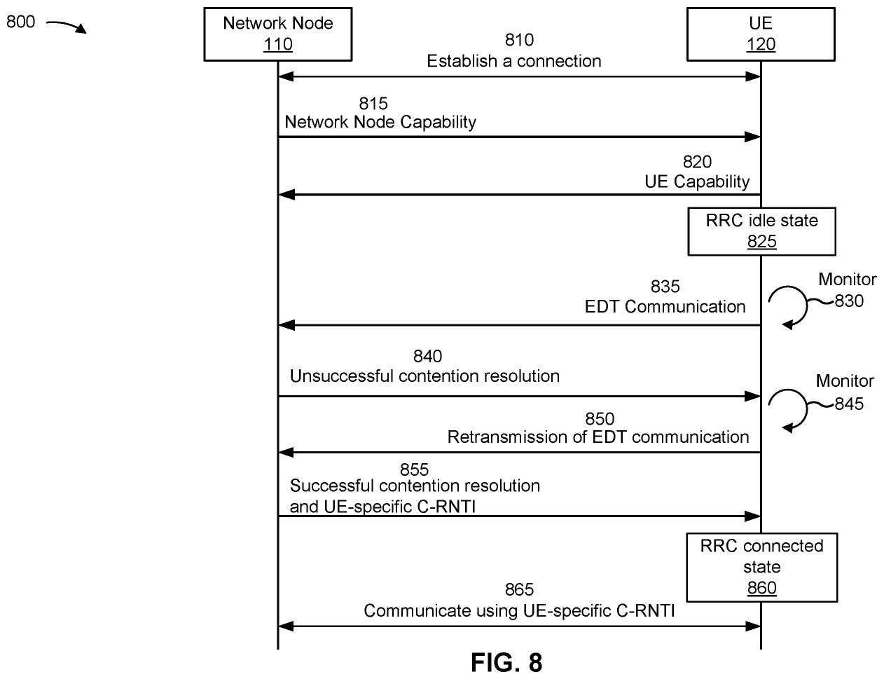

FIG. 8 is a diagram illustrating an example 800 of a wireless communication process between a network node (e.g., a network node 110) and a UE (e.g., a UE 120), in accordance with the present disclosure. At least some aspects of the example 800 may be combined with aspects of the example 700, such as in scenarios that include one or more UEs.

As shown by reference number 810, the network node 110 and the UE 120 may establish a connection. For example, the network node 110 and the UE 120 may establish the connection in a similar manner as described with regard to reference number 710.

As shown by reference number 815, the network node 110 may transmit, and the UE 120 may receive, an indication of a network node capability. For clarity, FIG. 8 shows the network node 110 transmitting the network node capability separately from establishing a connection with the UE 120, but in some examples, the network node 110 may transmit the indication of the network node capability as at least part of establishing a connection with the UE 120. To illustrate, the network node 110 may transmit the indication of the network node capability in a similar manner as described with regard to reference number 715.

As shown by reference number 820, the UE 120 may transmit, and the network node may receive, an indication of a UE capability. For clarity, FIG. 8 shows the UE 120 transmitting the indication of the UE capability separately from establishing a connection with the network node 110, but in some examples, UE 120 may transmit the indication of the UE capability as at least part of establishing a connection with the network node 110. For example, the UE 120 may transmit the indication of the UE capability in a similar manner as described with regard to reference number 720 to enable the network node 110 to assign a UE-specific C-RNTI to the UE 120, as further described below, and mitigate C-RNTI collisions. In some aspects, the UE 120 may transmit the indication of the UE capability prior to transmitting the EDT, and in other aspects, the UE 120 may transmit the indication of the UE capability (e.g., support for the UE-specific C-RNTI assignment for EDT) during an EDT communication, in an EDT communication, and/or in a transmission that carries the EDT communication.

As shown by reference number 825, the UE 120 may transition to an RRC idle state. To illustrate, the UE 120 may transition to the RRC idle state in a similar manner as described with regard to reference number 725.

As shown by reference number 830, the UE 120 may monitor a downlink channel, such as a PDCCH, using the multicast C-RNTI, such as a temporary C-RNTI and/or a common C-RNTI, that is shared with at least one other UE. For example, the UE 120 may monitor the downlink channel in a similar manner as described with regard to reference number 730.

As shown by reference number 835, the UE 120 may transmit, and the network node 110 may receive, an EDT communication. To illustrate, the UE 120 may transmit the EDT communication in a similar manner as described with regard to reference number 735. In some aspects, the UE 120 may transmit the EDT communication using a same PUSCH resource as another UE 120 and/or using a same RACH preamble as another UE 120. Alternatively, or additionally, the UE 120 may include, in the EDT communication, a contention resolution ID. Accordingly, the EDT communication may include a content resolution ID that is linked to a UE (e.g., the UE 120) that transmitted the EDT communication.

As shown by reference number 840, the network node 110 may transmit, and the UE 120 may receive, a downlink communication that indicates an unsuccessful contention resolution (e.g., a decoding failure). Alternatively, or additionally, the downlink communication may indicate to continue to monitor a downlink channel (e.g., a PDCCH) using the multicast C-RNTI. In some aspects, the downlink communication may indicate a retransmission grant that may be used for retransmitting the EDT communication.

The network node 110 may address the downlink communication may be a response communication to the EDT transmitted as described with regard to reference number 835. The response communication may be addressed with a multicast C-RNTI, and the response communication may indicate an unsuccessful content resolution of the EDT communication. For instance, the response communication may include a MAC PDU that indicates the unsuccessful content resolution.

As one example, the response communication may implicitly indicate an unsuccessful content resolution of the EDT communication described with regard to reference number 835 based at least in part on including a different content resolution ID (e.g., a content resolution ID associated with a different UE). To illustrate, the response communication may not include the content resolution ID that is linked to the UE 120. That is, the response communication may include a different content resolution ID that does not match the content resolution ID included in the EDT communication (e.g., that is linked to the UE 120 as described with reference number 835). As another example, the response communication may explicitly indicate the unsuccessful content resolution by including an explicit field that indicates a decoding failure of the EDT communication.

The response communication may alternatively or additionally indicate to continue using the multicast C-RNTI to monitor a downlink channel, such as a PDCCH. The indication to continue using the multicast C-RNTI to monitor a downlink channel may be implicit, such as through receiving an indication of an unsuccessful content resolution and/or receipt of a different content resolution ID, or explicit, such as through the addition of a field to the response communication and/or the field being set to a particular value (e.g., “1”).

In some aspects, the response communication may indicate the unsuccessful content resolution in a MAC CE. For instance, the response communication may include a CRI MAC CE and/or an EDT resolution MAC CE that include one or more field that may be used to indicate a successful content resolution (and/or an unsuccessful content resolution). The CRI MAC CE and/or the EDT resolution MAC CE may alternatively or additionally include a content resolution ID field. As another example, the response communication may indicate the unsuccessful content resolution in a sub-header of the MAC.

In some aspects, the response communication may indicate the unsuccessful content resolution in an RRC message. Alternatively, or additionally, DCI that schedules the response communication may indicate the unsuccessful content resolution.

The network node 110 may transmit the response communication as at least part of the RACH procedure (e.g., in a msg4 and/or a msgB). Alternatively, or additionally, the network node 110 may transmit, as at least part of the response communication, a PUSCH resource collision indicator that specifies that the EDT communication transmitted with regard to reference number 835 is associated with the unsuccessful content resolution. In some aspects, the PUSCH resource collision indicator may indicate a particular and/or specific PUSCH resource that is associated with a frequency collision and/or an unsuccessful contention resolution.

As shown by reference number 845, the UE 120 may monitor the downlink channel using the multicast C-RNTI. For example, the UE 120 may monitor the downlink channel in a similar manner as described with regard to reference number 730 and reference number 830.

As shown by reference number 850, the UE 120 may transmit, and the network node 110 may receive, a retransmission of the EDT communication. To illustrate, the UE 120 may transmit the EDT communication using a retransmission grant indicated in a response communication. Alternatively, or additionally, the UE 120 may retransmit the EDT communication without performing a content resolution failure procedure.

As shown by reference number 855, the network node 110 may transmit, and the UE 120 may receive, a downlink communication that indicates a successful content resolution that is associated with the EDT communication. Alternatively, or additionally, the downlink communication may indicate a UE-specific C-RNTI that is assigned to the UE 120. In some aspects, the downlink communication may be addressed to a multicast C-RNTI. For example, the network node 110 may transmit the downlink communication that indicates the successful content resolution (e.g., of the retransmission of the EDT communication) in a similar manner as described with regard to reference number 740.

As shown by reference number 860, the UE 120 may transition to an RRC connected state and/or an RRC active state. To illustrate, and in a similar manner as described with regard to reference number 740 and reference number 745, the downlink communication and/or the response communication may include an RRC setup message or an RRC resume message, resulting in the UE 120 transitioning to an RRC connected mode.

As shown by reference number 865, the UE 120 and the network node 110 may communicate with one another in a wireless network using the UE-specific C-RNTI. For example, the UE 120 and the network node 110 may communicate with one another in a similar manner as described with regard to reference number 750.

By indicating a UE-specific C-RNTI in a downlink communication that is addressed to a multicast C-RNTI, a network node may mitigate C-RNTI collisions. Mitigating C-RNTI collisions may result in mitigating communication failures at one or more UEs.

As indicated above, FIG. 8 is provided as an example. Other examples may differ from what is described with regard to FIG. 8.

FIG. 9 is a flowchart of an example method 900 of wireless communication. The method 900 may be performed at, for example, a UE (e.g., UE 120) or an apparatus of a UE.

Method 900 begins at 910 with transmitting an EDT communication. For example, the UE may transmit an EDT communication, as described above in connection with, for example, FIGS. 6A, 6B, 6C, 7, and 8 and at reference numbers 735 and 835.

Method 900 then proceeds at 920 with receiving a response communication that indicates a successful content resolution of the EDT communication, and a UE-specific C-RNTI. For example, the UE may receive a response communication that indicates: a successful content resolution of the EDT communication, and a UE-specific C-RNTI, as described above in connection with, for example, FIGS. 7 and 8 and at reference numbers 740 and 855.

In some aspects, method 900 includes communicating in a wireless network using the UE-specific C-RNTI based at least in part on the successful content resolution of the EDT communication.

In some aspects, the response communication is addressed to a multicast C-RNTI, and the multicast C-RNTI is a temporary C-RNTI, a configured RNTI, or an RNTI derived from the uplink transmission occasion of EDT.

In some aspects, method 900 includes discarding, based at least in part on the response communication indicating the successful content resolution of the EDT communication, use of the multicast C-RNTI for PDCCH monitoring.

In some aspects, method 900 includes monitoring, prior to receiving the response communication that indicates the successful content resolution, the PDCCH using the multicast C-RNTI.

In some aspects, transmitting the EDT communication includes transmitting the EDT communication as part of a RACH procedure, and receiving the response communication includes receiving the response communication as at least part of the RACH procedure.

In some aspects, the RACH procedure includes at least one of a four-step RACH procedure, or a two-step RACH procedure.

In some aspects, the response communication indicates the UE-specific C-RNTI in an RRC communication, a MAC CE, or DCI.

In some aspects, the response communication indicates the UE-specific C-RNTI in the RRC communication, and the RRC communication includes an RRC setup communication.

In some aspects, method 900 includes receiving, using the UE-specific C-RNTI, an RRC communication, the RRC communication comprising an RRC release message, an RRC early data complete message, an RRC setup message, or an RRC resume message.

In some aspects, the RRC communication includes the RRC release message or the RRC early data complete message, and the RRC communication includes a NAS PDU.

In some aspects, the RRC communication includes the RRC release message or the RRC early data complete message, and the RRC communication does not include a NAS PDU.

In some aspects, the RRC communication includes the RRC setup message or the RRC resume message, and the method includes transitioning to an RRC connected mode.

In some aspects, the indication of the UE-specific C-RNTI is an absolute C-RNTI.

In some aspects, the indication of the UE-specific C-RNTI is a delta C-RNTI that is based at least in part on a multicast C-RNTI used to address the response communication.

In some aspects, method 900 includes transmitting a capability indication that specifies support for a UE-specific C-RNTI assignment for EDT.

In some aspects, method 900 includes receiving the UE-specific C-RNTI assignment for EDT in a RACH communication.

In some aspects, transmitting the capability indication includes transmitting the capability indication in an RRC message, a MAC sub-header, or an LCID codepoint.

In some aspects, method 900 includes receiving a network node capability indication that specifies support for UE-specific C-RNTI assignment for EDT, and transmitting the capability indication that specifies the support for the UE-specific C-RNTI assignment for EDT is based at least in part on receiving the network node capability indication.

In some aspects, receiving the network node capability indication includes receiving the network node capability indication in a SIB.

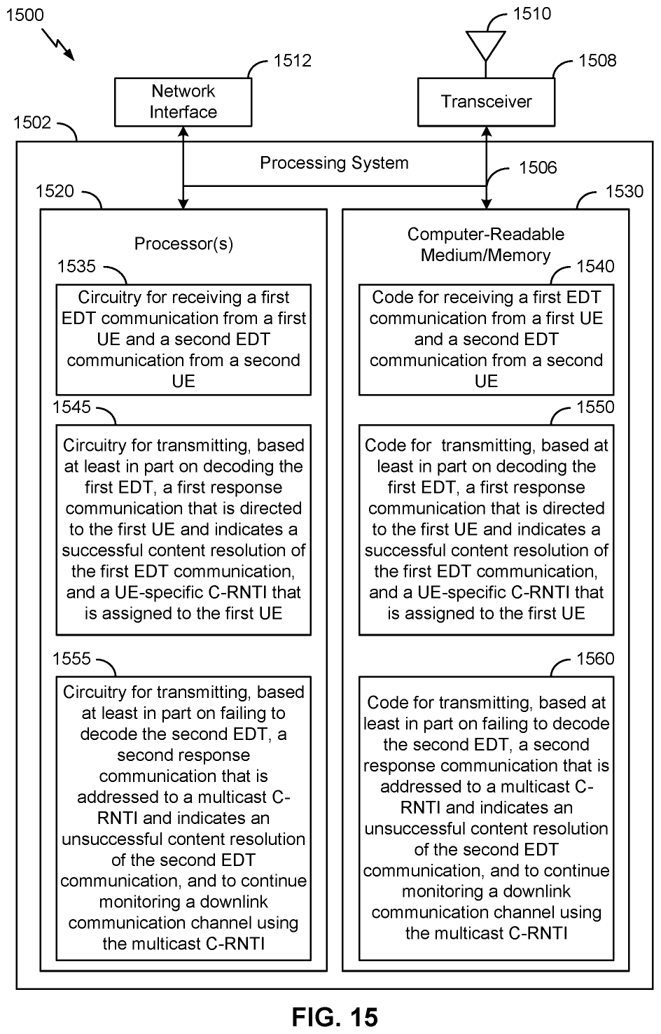

In one aspect, method 900, or any aspect related to it, may be performed by an apparatus, such as communications device 1500 of FIG. 15, which includes various components operable, configured, or adapted to perform the method 900. Communications device 1500 is described below in further detail.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

FIG. 10 is a flowchart of an example method 1000 of wireless communication. The method 1000 may be performed at, for example, a UE (e.g., UE 120) or an apparatus of a UE.

Method 1000 begins at 1010 with transmitting an EDT communication. For example, the UE may transmit an EDT communication, as described above in connection with, for example, FIGS. 6A, 6B, 6C, 7, and 8 and at reference numbers 735 and 835.

Method 1000 then proceeds at 1020 with receiving a response communication that is addressed to a multicast C-RNTI, the response communication indicating: an unsuccessful content resolution of the EDT communication, and to continue monitoring a downlink communication channel using the multicast C-RNTI. For example, the UE may receive a response communication that is addressed to a multicast C-RNTI, the multicast C-RNTI comprising: a temporary C-RNTI, a configured RNTI, or an RNTI derived from the uplink transmission occasion of EDT, the response communication indicating: an unsuccessful content resolution of the EDT communication, and to continue monitoring a downlink communication channel using the multicast C-RNTI, as described above in connection with, for example, FIG. 8 and at reference number 840.

In some aspects, the response communication includes a retransmission grant for the EDT communication, and the method includes retransmitting the EDT communication using the retransmission grant and without performing a content resolution failure procedure.

In some aspects, receiving the response communication that indicates the unsuccessful content resolution includes receiving a MAC PDU that indicates the unsuccessful content resolution.

In some aspects, the EDT communication includes a content resolution ID that is linked to a UE (e.g. a UE 120 and/or a UE 120 that includes the apparatus), and the response communication that indicates the unsuccessful contention resolution does not include the content resolution ID that is linked to the UE.

In some aspects, the response communication indicates the unsuccessful content resolution in a MAC CE.

In some aspects, the MAC CE includes a CRI MAC CE, or an EDT resolution MAC CE.

In some aspects, the response communication indicates the unsuccessful content resolution in a sub-header of the MAC.

In some aspects, the response communication indicates the unsuccessful content resolution in an RRC message, or DCI that schedules the response communication.

In some aspects, transmitting the EDT communication includes transmitting the EDT communication as part of a RACH procedure, and receiving the response communication includes receiving the response communication as at least part of the RACH procedure.

In some aspects, receiving the response communication that indicates the unsuccessful content resolution of the EDT communication includes receiving a PUSCH resource collision indicator that specifies that the EDT communication is associated with the unsuccessful content resolution.

In some aspects, method 1000 includes transmitting a capability indication that specifies support for a UE-specific C-RNTI assignment for EDT.

In some aspects, the UE-specific C-RNTI assignment for EDT uses a RACH communication.

In some aspects, transmitting the capability indication includes transmitting the capability indication in an RRC message, a MAC sub-header, or an LCID codepoint.

In some aspects, method 1000 includes receiving a network node capability indication that specifies the support for the UE-specific C-RNTI assignment for EDT, and transmitting the capability indication that specifies the support for the UE-specific C-RNTI assignment for EDT is based at least in part on receiving the network node capability indication.

In some aspects, receiving the network node capability indication includes receiving the network node capability indication in a SIB.

In one aspect, method 1000, or any aspect related to it, may be performed by an apparatus, such as communications device 1500 of FIG. 15, which includes various components operable, configured, or adapted to perform the method 1000. Communications device 1500 is described below in further detail.

Although FIG. 10 shows example blocks of method 1000, in some aspects, method 1000 may include additional blocks, fewer blocks, different blocks, or differently arranged blocks than those depicted in FIG. 10. Additionally, or alternatively, two or more of the blocks of method 1000 may be performed in parallel.

FIG. 11 is a flowchart of an example method 1100 of wireless communication. The method 1100 may be performed at, for example, a network node (e.g., network node 110) or an apparatus of a network node.

Method 1100 begins at 1110 with receiving a first EDT communication from a first UE and a second EDT communication from a second UE. For example, the network node may receive a first EDT communication from a first UE and a second EDT communication from a second UE, as described above in connection with, for example, FIGS. 6A, 6B, 6C, 7, and 8 and at reference numbers 735 and 835.

Method 1100 then proceeds at 1120 with transmitting, based at least in part on decoding the first EDT, a first response communication that is directed to the first UE and indicates: a successful content resolution of the first EDT communication, and a UE-specific C-RNTI that is assigned to the first UE. For example, the network node may transmit, based at least in part on decoding the first EDT, a first response communication that is directed to the first UE and indicates: a successful content resolution of the first EDT communication, and a UE-specific C-RNTI that is assigned to the first UE, as described above in connection with, for example, FIG. 7 and at reference number 740.

In some aspects, method 1100 includes communicating in a wireless network with the first UE using the UE-specific C-RNTI and based at least in part on the successful content resolution of the EDT communication.

In some aspects, the first response communication is addressed to a multicast C-RNTI.

In some aspects, receiving the first EDT communication includes receiving the first EDT communication as part of a RACH procedure, and transmitting the first response communication includes transmitting the first response communication as at least part of the RACH procedure.

In some aspects, the RACH procedure includes at least one of a four-step RACH procedure, or a two-step RACH procedure.

In some aspects, the first response communication indicates the UE-specific C-RNTI in an RRC communication, a MAC CE, or DCI.

In some aspects, the first response communication indicates the UE-specific C-RNTI in the RRC communication, and the RRC communication includes an RRC setup communication.

In some aspects, method 1100 includes transmitting, using the UE-specific C-RNTI, an RRC communication, the RRC communication comprising an RRC release message, an RRC early data complete message, an RRC setup message, or an RRC resume message.

In some aspects, the RRC communication includes the RRC release message or the RRC early data complete message, and the RRC communication includes a NAS PDU.

In some aspects, the RRC communication includes the RRC release message or the RRC early data complete message, and the RRC communication does not include a NAS PDU.

In some aspects, the indication of the UE-specific C-RNTI is an absolute C-RNTI.

In some aspects, the indication of the UE-specific C-RNTI is a delta C-RNTI that is based at least in part on a multicast C-RNTI that is used to address the first response communication, the multicast C-RNTI comprising: a temporary C-RNTI, a configured RNTI, or an RNTI derived from the uplink transmission occasion of EDT.

In some aspects, method 1100 includes transmitting, based at least in part on failing to decode the second EDT communication, a second response communication that is addressed to the multicast C-RNTI and indicates an unsuccessful content resolution of the second EDT communication, and an indication to continue monitoring a PDCCH using the multicast C-RNTI.

In some aspects, the second response communication includes a retransmission grant for the EDT communication.

In some aspects, transmitting the second response communication that indicates the unsuccessful content resolution includes transmitting a MAC PDU that indicates the unsuccessful content resolution.

In some aspects, the second EDT communication includes a content resolution ID that is linked to the second UE, and the second response communication that indicates the unsuccessful content resolution does not include the content resolution ID that is linked to the second UE.

In some aspects, the second response communication indicates the unsuccessful content resolution in a MAC CE.

In some aspects, the MAC CE includes a CRI MAC CE, or an EDT resolution MAC CE.

In some aspects, the second response communication indicates the unsuccessful content resolution in a sub-header of the MAC.

In some aspects, method 1100 includes transmitting a network node capability indication that specifies support for a UE-specific C-RNTI assignment for EDT.

In some aspects, method 1100 includes receiving at least one of a first capability indication that specifies that the first UE supports the UE-specific C-RNTI assignment for EDT, or a second capability indication that specifies that the second UE supports the UE-specific C-RNTI assignment for EDT.

In some aspects, the UE-specific C-RNTI assignment for EDT uses a RACH communication.

In some aspects, transmitting the network node capability indication includes transmitting the network node capability indication in a SIB.

In one aspect, method 1100, or any aspect related to it, may be performed by an apparatus, such as communications device 1500 of FIG. 15, which includes various components operable, configured, or adapted to perform the method 1100. Communications device 1500 is described below in further detail.

Although FIG. 11 shows example blocks of method 1100, in some aspects, method 1100 may include additional blocks, fewer blocks, different blocks, or differently arranged blocks than those depicted in FIG. 11. Additionally, or alternatively, two or more of the blocks of method 1100 may be performed in parallel.

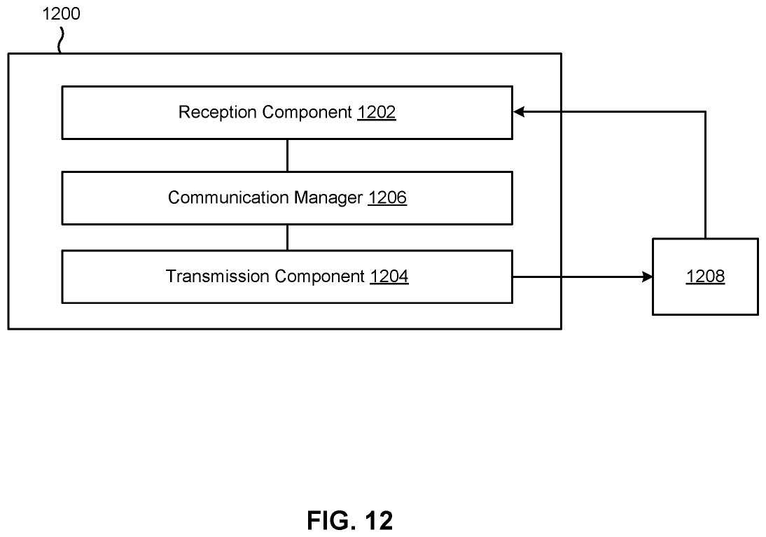

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6A-8. Additionally, or alternatively, the apparatus 1200 may be configured to perform one or more processes described herein, such as method 900 of FIG. 9, method 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit an EDT communication. The reception component 1202 may receive a response communication that indicates a successful content resolution of the EDT communication, and a UE-specific C-RNTI.

The communication manager 1206 may communicate in a wireless network using the UE-specific C-RNTI based at least in part on the successful content resolution of the EDT communication. Alternatively, or additionally, the communication manager 1206 may discard, based at least in part on the response communication indicating the successful content resolution of the EDT communication, use of the multicast C-RNTI for PDCCH monitoring. In some aspects, the communication manager 1206 may monitor, prior to receiving the response communication that indicates the successful content resolution, the PDCCH using the multicast C-RNTI.

The reception component 1202 may receive, using the UE-specific C-RNTI, an RRC communication, the RRC communication including an RRC release message, an RRC early data complete message, an RRC setup message, or an RRC resume message. In some aspects, the transmission component 1204 may transmit a capability indication that specifies support for a UE-specific C-RNTI assignment for EDT.

The reception component 1202 may receive the UE-specific C-RNTI assignment for EDT in a RACH communication. In some aspects, the reception component 1202 may receive a network node capability indication that specifies support for UE-specific C-RNTI assignment for EDT and transmitting the capability indication that specifies the support for the UE-specific C-RNTI assignment for EDT is based at least in part on receiving the network node capability indication.

The transmission component 1204 may transmit an EDT communication. The reception component 1202 may receive a response communication that is addressed to a multicast C-RNTI, the multicast C-RNTI comprising: a temporary C-RNTI, a configured RNTI, or an RNTI derived from the uplink transmission occasion of EDT, the response communication indicating an unsuccessful content resolution of the EDT communication and to continue monitoring a downlink communication channel using the multicast C-RNTI.

The transmission component 1204 may transmit a capability indication that specifies support for a UE-specific C-RNTI assignment for EDT. In some aspects, the reception component 1202 may receive a network node capability indication that specifies the support for the UE-specific C-RNTI assignment for EDT and transmitting the capability indication that specifies the support for the UE-specific C-RNTI assignment for EDT is based at least in part on receiving the network node capability indication.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

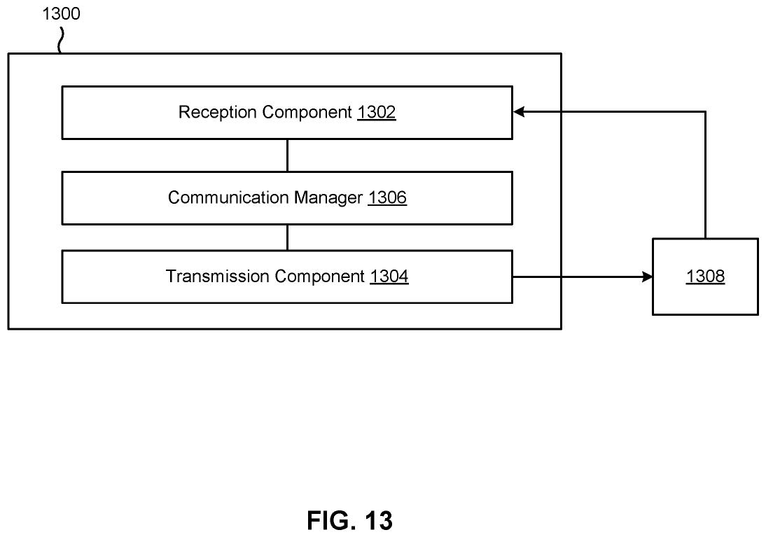

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 6A-8. Additionally, or alternatively, the apparatus 1300 may be configured to perform one or more processes described herein, such as method 1100 of FIG. 11, or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a first EDT communication from a first UE and a second EDT communication from a second UE. The transmission component 1304 may transmit, based at least in part on decoding the first EDT, a first response communication that is directed to the first UE and indicates a successful content resolution of the first EDT communication, and a UE-specific C-RNTI that is assigned to the first UE.

The communication manager 1306 may communicate in a wireless network with the first UE using the UE-specific C-RNTI and based at least in part on the successful content resolution of the EDT communication. In some aspects, the transmission component 1304 may transmit, using the UE-specific C-RNTI, an RRC communication, the RRC communication including an RRC release message, an RRC early data complete message, an RRC setup message, or an RRC resume message.

The transmission component 1304 may transmit, based at least in part on failing to decode the second EDT communication, a second response communication that is addressed to a multicast C-RNTI and indicates an unsuccessful content resolution of the second EDT communication and to continue monitoring a PDCCH using the multicast C-RNTI.

The transmission component 1304 may transmit a network node capability indication that specifies support for a UE-specific C-RNTI assignment for EDT. In some aspects, the reception component 1302 may receive at least one of a first capability indication that specifies that the first UE supports the UE-specific C-RNTI assignment for EDT, or a second capability indication that specifies that the second UE supports the UE-specific C-RNTI assignment for EDT.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

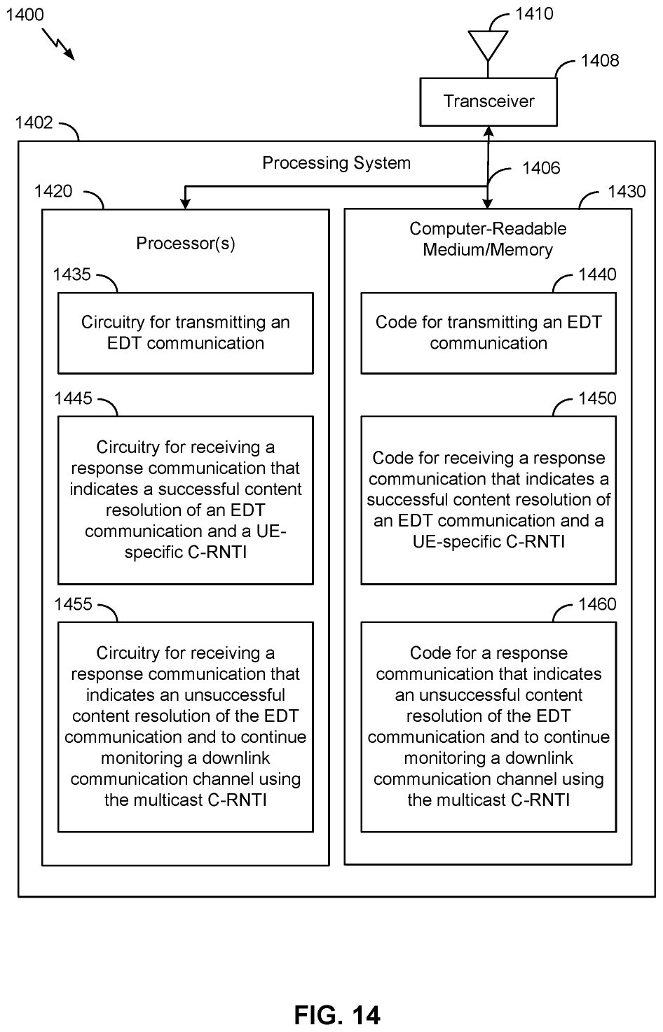

FIG. 14 is a diagram illustrating an example of an implementation of code and circuitry for a communications device 1400, in accordance with the present disclosure. The communications device 1400 may be a UE, or a UE may include the communications device 1400.

The communications device 1400 includes a processing system 1402 coupled to a transceiver 1408 (e.g., a transmitter and/or a receiver, and which may include a single transceivers or multiple transceivers which may perform different operations described as being performed by the transceiver 1408). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may include one or more of receive processor 258, transmit processor 264, TX MIMO processor 266, and/or controller/processor 280, as described with respect to FIG. 2. The one or more processors 1420 are coupled to a computer-readable medium/memory 1430 via a bus 1406. In various aspects, the computer-readable medium/memory 1430 may include one or more memories such as memory 282, as described with respect to FIG. 2. In certain aspects, the computer-readable medium/memory 1430 is configured to store instructions (e.g., computer-executable code, processor-executable code) that when executed by the one or more processors 1420, cause the one or more processors 1420 to perform the method 900 described with respect to FIG. 9, or any aspect related to it. Note that reference to a processor performing a function of communications device 1400 may include one or more processors performing that function of communications device 1400. Note also that reference to one or more processors performing multiple functions may include a first processor performing a first function of the multiple functions and a second processor performing a second function of the multiple functions.

As shown in FIG. 14, the communications device 1400 may include circuitry for transmitting an EDT communication (circuitry 1435).

As shown in FIG. 14, the communications device 1400 may include, stored in computer-readable medium/memory 1430, code for transmitting an EDT communication (code 1440).

As shown in FIG. 14, the communications device 1400 may include circuitry for receiving a response communication that indicates a successful content resolution of the EDT communication and a UE-specific C-RNTI (circuitry 1445).

As shown in FIG. 14, the communications device 1400 may include, stored in computer-readable medium/memory 1430, code for receiving a response communication that indicates a successful content resolution of the EDT communication and a UE-specific C-RNTI (code 1450).

As shown in FIG. 14, the communications device 1400 may include circuitry for receiving a response communication that is addressed to a multicast C-RNTI, the multicast C-RNTI comprising: a temporary C-RNTI, a configured RNTI, or an RNTI derived from the uplink transmission occasion of EDT, the response communication indicating an unsuccessful content resolution of the EDT communication, and to continue monitoring a downlink communication channel using the multicast C-RNTI (circuitry 1455).

As shown in FIG. 14, the communications device 1400 may include, stored in computer-readable medium/memory 1430, code for receiving a response communication that is addressed to a multicast C-RNTI, the multicast C-RNTI comprising: a temporary C-RNTI, a configured RNTI, or an RNTI derived from the uplink transmission occasion of EDT, the response communication indicating an unsuccessful content resolution of the EDT communication, and to continue monitoring a downlink communication channel using the multicast C-RNTI (code 1460).

Various components of the communications device 1400 may provide means for performing the method 900 described with respect to FIG. 9, and/or means for performing the method 1000 described with respect to FIG. 10, or any aspect related to either or both methods. For example, means for transmitting, sending, or outputting for transmission may include the modem(s) 254 and/or antenna(s) 252 of the UE 120 and/or transceiver 1408 and antenna 1410 of the communications device 1400 in FIG. 14. Means for receiving or obtaining may include the modem(s) 254 and/or antenna(s) 252 of the UE 120 and/or transceiver 1408 and antenna 1410 of the communications device 1400 in FIG. 14.

FIG. 14 is provided as an example. Other examples may differ from what is described in connection with FIG. 14.

FIG. 15 is a diagram illustrating an example of an implementation of code and circuitry for a communications device 1500, in accordance with the present disclosure. The communications device 1500 may be a network node (such as network node 110 or a disaggregated base station as described with regard to FIG. 3), or a network node may include the communications device 1500.

The communications device 1500 includes a processing system 1502 coupled to a transceiver 1508 (e.g., a transmitter and/or a receiver, and which may include a single transceivers or multiple transceivers which may perform different operations described as being performed by the transceiver 1408). The transceiver 1508 is configured to transmit and receive signals for the communications device 1500 via an antenna 1510 (e.g., one or more antennas), such as the various signals as described herein. The network interface 1512 is configured to obtain and send signals for the communications device 1500 via communications link(s), such as a backhaul link, midhaul link, and/or fronthaul link as described herein, such as with respect to FIG. 3. The processing system 1502 may be configured to perform processing functions for the communications device 1500, including processing signals received and/or to be transmitted by the communications device 1500.

The processing system 1502 includes one or more processors 1520. In various aspects, the one or more processors 1520 may include one or more of receive processor 238, transmit processor 220, TX MIMO processor 230, and/or controller/processor 240, as described with respect to FIG. 2. The one or more processors 1520 are coupled to a computer-readable medium/memory 1530 via a bus 1506. In various aspects, the computer-readable medium/memory 1530 may include one or more memories such as memory 242, as described with respect to FIG. 2. In certain aspects, the computer-readable medium/memory 1530 is configured to store instructions (e.g., computer-executable code, processor-executable code) that when executed by the one or more processors 1520, cause the one or more processors 1520 to perform the method 1100 described with respect to FIG. 11, or any aspect related to it. Note that reference to a processor performing a function of communications device 1500 may include one or more processors performing that function of communications device 1500. Note also that reference to one or more processors performing multiple functions may include a first processor performing a first function of the multiple functions and a second processor performing a second function of the multiple functions.

As shown in FIG. 15, the communications device 1500 may include circuitry for receiving a first EDT communication from a first UE and a second EDT communication from a second UE (circuitry 1535).

As shown in FIG. 15, the communications device 1500 may include, stored in computer-readable medium/memory 1530, code for receiving a first EDT communication from a first UE and a second EDT communication from a second UE (code 1540).

As shown in FIG. 15, the communications device 1500 may include circuitry for transmitting, based at least in part on decoding the first EDT, a first response communication that is directed to the first UE and indicates a successful content resolution of the first EDT communication, and a UE-specific C-RNTI that is assigned to the first UE (circuitry 1545).

As shown in FIG. 15, the communications device 1500 may include, stored in computer-readable medium/memory 1530, code for transmitting, based at least in part on decoding the first EDT, a first response communication that is directed to the first UE and indicates a successful content resolution of the first EDT communication, and a UE-specific C-RNTI that is assigned to the first UE (code 1550).

As shown in FIG. 15, the communications device 1500 may include circuitry for transmitting, based at least in part on failing to decode the second EDT communication, a second response communication that is addressed to a multicast C-RNTI and indicates an unsuccessful content resolution of the second EDT communication, and to continue monitoring a downlink communication channel (e.g., a PDCCH) using the multicast C-RNTI (code 1555).

As shown in FIG. 15, the communications device 1500 may include, stored in computer-readable medium/memory 1530, code transmitting, based at least in part on failing to decode the second EDT communication, a second response communication that is addressed to a multicast C-RNTI and indicates an unsuccessful content resolution of the second EDT communication, and to continue monitoring a downlink communication channel (e.g., a PDCCH) using the multicast C-RNTI (code 1560).

Various components of the communications device 1500 may provide means for performing the method 1100 described with respect to FIG. 1100, or any aspect related to it. For example, means for transmitting, sending, or outputting for transmission may include the modem(s) 232 and/or antenna(s) 234 of the network node 110 and/or the transceiver 1508 and/or antenna 1510 of the communications device 1500 in FIG. 15. Means for receiving or obtaining may include modem(s) 232 and/or antenna(s) 234 of the network node 110 and/or the transceiver 1508 and/or antenna 1510 of the communications device 1500 in FIG. 15.

FIG. 15 is provided as an example. Other examples may differ from what is described in connection with FIG. 15.

The following provides an overview of some Aspects of the present disclosure:

Aspect 1: A method of wireless communication performed by a user equipment (UE), comprising: transmitting an early data transmission (EDT) communication; and receiving a response communication that indicates: a successful content resolution of the EDT communication, and a UE-specific cell radio network temporary identifier (C-RNTI).

Aspect 2: The method of Aspect 1, comprising: communicating in a wireless network using the UE-specific C-RNTI based at least in part on the successful content resolution of the EDT communication.

Aspect 3: The method of Aspect 1 or Aspect 2, wherein the response communication is addressed to a multicast C-RNTI, and wherein the multicast C-RNTI comprises a temporary C-RNTI, a configured RNTI, or an RNTI derived from the uplink transmission occasion of EDT.

Aspect 4: The method of any one of Aspects 1-3, comprising: discarding, based at least in part on the response communication indicating the successful content resolution of the EDT communication, use of the multicast C-RNTI for physical downlink control channel (PDCCH) monitoring.

Aspect 5: The method of any one of Aspects 1-4, comprising: monitoring, prior to receiving the response communication that indicates the successful content resolution, the PDCCH using the multicast C-RNTI.

Aspect 6: The method of any of Aspects 1-5, wherein transmitting the EDT communication comprises: transmitting the EDT communication as part of a random access channel (RACH) procedure, and wherein receiving the response communication comprises: receiving the response communication as at least part of the RACH procedure.

Aspect 7: The method of Aspect 6, wherein the RACH procedure comprises at least one of: a four-step RACH procedure, or a two-step RACH procedure.

Aspect 8: The method of any of Aspects 1-7, wherein the response communication indicates the UE-specific C-RNTI in: a radio resource control (RRC) communication, a medium access control (MAC) control element (CE), or downlink control information (DCI).

Aspect 9: The method of Aspect 8, wherein the response communication indicates the UE-specific C-RNTI in the RRC communication, and wherein the RRC communication comprises an RRC setup communication.

Aspect 10: The method of any of Aspects 1-9, comprising: receiving, using the UE-specific C-RNTI, a radio resource control (RRC) communication, the RRC communication comprising: an RRC release message, an RRC early data complete message, an RRC setup message, or an RRC resume message.

Aspect 11: The method of Aspect 10, wherein the RRC communication comprises the RRC release message or the RRC early data complete message, and wherein the RRC communication includes a non-access stratum (NAS) protocol data unit (PDU).

Aspect 12: The method of Aspect 10, wherein the RRC communication comprises the RRC release message or the RRC early data complete message, and wherein the RRC communication does not include a non-access stratum (NAS) protocol data unit (PDU).

Aspect 13: The method of Aspect 10, wherein the RRC communication comprises the RRC setup message or the RRC resume message, and wherein the method comprises: transitioning to an RRC connected mode.

Aspect 14: The method of any of Aspects 1-13, wherein the indication of the UE-specific C-RNTI is an absolute C-RNTI.

Aspect 15: The method of any of Aspects 1-14, wherein the indication of the UE-specific C-RNTI is a delta C-RNTI that is based at least in part on a multicast C-RNTI used to address the response communication.

Aspect 16: The method of any of Aspects 1-15, comprising: transmitting a capability indication that specifies support for a UE-specific C-RNTI assignment for EDT.

Aspect 17: The method of any one of Aspects 1-16, comprising: receiving the UE-specific C-RNTI assignment for EDT in a random access channel (RACH) communication.

Aspect 18: The method of Aspect 16 or Aspect 17, wherein transmitting the capability indication comprises: transmitting the capability indication in: a radio resource control (RRC) message, a medium access control (MAC) sub-header, or a logical channel identifier (LCID) codepoint.

Aspect 19: The method of any one of Aspects 16-19, comprising: receiving a network node capability indication that specifies support for UE-specific C-RNTI assignment for EDT, wherein transmitting the capability indication that specifies the support for the UE-specific C-RNTI assignment for EDT is based at least in part on receiving the network node capability indication.

Aspect 20: The method of any one of Aspects 16-19, wherein receiving the network node capability indication comprises: receiving the network node capability indication in a system information block (SIB).

Aspect 21: A method of wireless communication performed by a user equipment (UE), comprising: transmitting an early data transmission (EDT) communication; and receiving a response communication that is addressed to a multicast cell radio network temporary identifier (C-RNTI), the multicast C-RNTI comprising: a temporary C-RNTI, a configured RNTI, or an RNTI derived from the uplink transmission occasion of EDT, the response communication indicating: an unsuccessful content resolution of the EDT communication, and to continue monitoring a downlink communication channel using the multicast C-RNTI.

Aspect 22: The method of Aspect 21, wherein the response communication comprises a retransmission grant for the EDT communication, and wherein the method comprises: retransmitting the EDT communication using the retransmission grant and without performing a content resolution failure procedure.

Aspect 23: The method of any of Aspects 21-22, wherein receiving the response communication that indicates the unsuccessful content resolution comprises: receiving a medium access control (MAC) protocol data unit (PDU) that indicates the unsuccessful content resolution.

Aspect 24: The method of any of Aspects 21-23, wherein the EDT communication includes a content resolution identifier (ID) that is linked to a user equipment (UE) that is associated with an apparatus, and wherein the response communication that indicates the unsuccessful content resolution does not include the content resolution ID that is linked to the UE.

Aspect 25: The method of any of Aspects 21-24, wherein the response communication indicates the unsuccessful content resolution in a medium access control (MAC) control element (CE).

Aspect 26: The method of Aspect 25, wherein the MAC CE comprises: a contention resolution identity (CRI) MAC CE, or an EDT resolution MAC CE.

Aspect 27: The method of Aspect 25 or Aspect 26, wherein the response communication indicates the unsuccessful content resolution in a sub-header of the MAC.

Aspect 28: The method of any of Aspects 21-27, wherein the response communication indicates the unsuccessful content resolution in: a radio resource control (RRC) message, or downlink control information (DCI) that schedules the response communication.

Aspect 29: The method of any of Aspects 21-28, wherein transmitting the EDT communication comprises: transmitting the EDT communication as part of a random access channel (RACH) procedure, and wherein receiving the response communication comprises: receiving the response communication as at least part of the RACH procedure.

Aspect 30: The method of any of Aspects 21-29, wherein receiving the response communication that indicates the unsuccessful content resolution of the EDT communication comprises: receiving a physical uplink shared channel (PUSCH) resource collision indicator that specifies that the EDT communication is associated with the unsuccessful content resolution.

Aspect 31: The method of any of Aspects 21-30, comprising: transmitting a capability indication that specifies support for a UE-specific C-RNTI assignment for EDT.

Aspect 32: The method of Aspect 31, wherein the UE-specific C-RNTI assignment for EDT uses a random access channel (RACH) communication.

Aspect 33: The method of Aspect 31 or Aspect 32, wherein transmitting the capability indication comprises: transmitting the capability indication in: a radio resource control (RRC) message, a medium access control (MAC) sub-header, or a logical channel identifier (LCID) codepoint.

Aspect 34: The method of any one of Aspects 21-31, comprising: receiving a network node capability indication that specifies the support for the UE-specific C-RNTI assignment for EDT, wherein transmitting the capability indication that specifies the support for the UE-specific C-RNTI assignment for EDT is based at least in part on receiving the network node capability indication.

Aspect 35: The method of Aspect 34, wherein receiving the network node capability indication comprises: receiving the network node capability indication in a system information block (SIB).

Aspect 36: A method of wireless communication performed by a network node, comprising: receiving a first early data transmission (EDT) communication from a first user equipment (UE) and a second EDT communication from a second UE; and transmitting, based at least in part on decoding the first EDT, a first response communication that is directed to the first UE and indicates: a successful content resolution of the first EDT communication, and a UE-specific C-RNTI that is assigned to the first UE.

Aspect 37: The method of Aspect 36, comprising: communicating in a wireless network with the first UE using the UE-specific C-RNTI and based at least in part on the successful content resolution of the EDT communication.

Aspect 38: The method of any of Aspects 36-37, wherein the first response communication is addressed to a multicast C-RNTI.

Aspect 39: The method of any of Aspects 36-38, wherein receiving the first EDT communication comprises: receiving the first EDT communication as part of a random access channel (RACH) procedure, and wherein transmitting the first response communication comprises: transmitting the first response communication as at least part of the RACH procedure.

Aspect 40: The method of Aspect 39, wherein the RACH procedure comprises at least one of: a four-step RACH procedure, or a two-step RACH procedure.

Aspect 41: The method of any of Aspects 36-40, wherein the first response communication indicates the UE-specific C-RNTI in: a radio resource control (RRC) communication, a medium access control (MAC) control element (CE), or downlink control information (DCI).

Aspect 42: The method of Aspect 41, wherein the first response communication indicates the UE-specific C-RNTI in the RRC communication, and wherein the RRC communication comprises an RRC setup communication.

Aspect 43: The method of any of Aspects 36-42, comprising: transmitting, using the UE-specific C-RNTI, a radio resource control (RRC) communication, the RRC communication comprising: an RRC release message, an RRC early data complete message, an RRC setup message, or an RRC resume message.

Aspect 44: The method of Aspect 43, wherein the RRC communication comprises the RRC release message or the RRC early data complete message, and wherein the RRC communication includes a non-access stratum (NAS) protocol data unit (PDU).

Aspect 45: The method of Aspect 43, wherein the RRC communication comprises the RRC release message or the RRC early data complete message, and wherein the RRC communication does not include a non-access stratum (NAS) protocol data unit (PDU).

Aspect 46: The method of any of Aspects 36-45, wherein the indication of the UE-specific C-RNTI is an absolute C-RNTI.

Aspect 47: The method of any of Aspects 36-46, wherein the indication of the UE-specific C-RNTI is a delta C-RNTI that is based at least in part on a multicast C-RNTI that is used to address the first response communication.

Aspect 48: The method of any of Aspects 36-47, comprising: transmitting, based at least in part on failing to decode the second EDT communication, a second response communication that is addressed to a multicast C-RNTI and indicates: an unsuccessful content resolution of the second EDT communication, and an indication to continue monitoring a physical downlink control channel (PDCCH) using the multicast C-RNTI.

Aspect 49: The method of Aspect 48, wherein the second response communication comprises a retransmission grant for the EDT communication.

Aspect 50: The method of Aspect 48, wherein transmitting the second response communication that indicates the unsuccessful content resolution comprises: transmitting a medium access control (MAC) protocol data unit (PDU) that indicates the unsuccessful content resolution.

Aspect 51: The method of Aspect 48, wherein the second EDT communication includes a content resolution identifier (ID) that is linked to the second UE, and wherein the second response communication that indicates the unsuccessful content resolution does not include the content resolution ID that is linked to the second UE.

Aspect 52: The method of Aspect 48, wherein the second response communication indicates the unsuccessful content resolution in a medium access control (MAC) control element (CE).

Aspect 53: The method of Aspect 52, wherein the MAC CE comprises: a control resource indication (CRI) MAC CE, or an EDT resolution MAC CE.

Aspect 54: The method of Aspect 52, wherein the second response communication indicates the unsuccessful content resolution in a sub-header of the MAC.

Aspect 55: The method of any of Aspects 36-54, comprising: transmitting a network node capability indication that specifies support for a UE-specific C-RNTI assignment for EDT.

Aspect 56: The method of Aspect 55, comprising: receiving at least one of: a first capability indication that specifies that the first UE supports the UE-specific C-RNTI assignment for EDT, or a second capability indication that specifies that the second UE supports the UE-specific C-RNTI assignment for EDT.

Aspect 57: The method of Aspect 55, wherein the UE-specific C-RNTI assignment for EDT uses a random access channel (RACH) communication.

Aspect 58: The method of Aspect 55, wherein transmitting the network node capability indication comprises: transmitting the network node capability indication in a system information block (SIB).

Aspect 59: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 60: An apparatus for wireless communication at a device, the apparatus comprising one or more memories and one or more processors coupled to the one or more memories, the one or more processors configured to cause the device to perform the method of one or more of Aspects 1-20.

Aspect 61: An apparatus for wireless communication, the apparatus comprising at least one means for performing the method of one or more of Aspects 1-20.

Aspect 62: A non-transitory computer-readable medium storing code for wireless communication, the code comprising instructions executable by one or more processors to perform the method of one or more of Aspects 1-20.

Aspect 63: A non-transitory computer-readable medium storing a set of instructions for wireless communication, the set of instructions comprising one or more instructions that, when executed by one or more processors of a device, cause the device to perform the method of one or more of Aspects 1-20.

Aspect 64: A device for wireless communication, the device comprising a processing system that includes one or more processors and one or more memories coupled with the one or more processors, the processing system configured to cause the device to perform the method of one or more of Aspects 1-20.

Aspect 65: An apparatus for wireless communication at a device, the apparatus comprising one or more memories and one or more processors coupled to the one or more memories, the one or more processors individually or collectively configured to cause the device to perform the method of one or more of Aspects 1-58.

Aspect 66: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 21-35.

Aspect 67: An apparatus for wireless communication at a device, the apparatus comprising one or more memories and one or more processors coupled to the one or more memories, the one or more processors configured to cause the device to perform the method of one or more of Aspects 21-35.

Aspect 68: An apparatus for wireless communication, the apparatus comprising at least one means for performing the method of one or more of Aspects 21-35.

Aspect 69: A non-transitory computer-readable medium storing code for wireless communication, the code comprising instructions executable by one or more processors to perform the method of one or more of Aspects 21-35.

Aspect 70: A non-transitory computer-readable medium storing a set of instructions for wireless communication, the set of instructions comprising one or more instructions that, when executed by one or more processors of a device, cause the device to perform the method of one or more of Aspects 21-35.

Aspect 71: A device for wireless communication, the device comprising a processing system that includes one or more processors and one or more memories coupled with the one or more processors, the processing system configured to cause the device to perform the method of one or more of Aspects 21-35.

Aspect 72: An apparatus for wireless communication at a device, the apparatus comprising one or more memories and one or more processors coupled to the one or more memories, the one or more processors individually or collectively configured to cause the device to perform the method of one or more of Aspects 21-35.

Aspect 73: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 36-58.

Aspect 74: An apparatus for wireless communication at a device, the apparatus comprising one or more memories and one or more processors coupled to the one or more memories, the one or more processors configured to cause the device to perform the method of one or more of Aspects 36-58.

Aspect 75: An apparatus for wireless communication, the apparatus comprising at least one means for performing the method of one or more of Aspects 36-58.

Aspect 76: A non-transitory computer-readable medium storing code for wireless communication, the code comprising instructions executable by one or more processors to perform the method of one or more of Aspects 36-58.

Aspect 77: A non-transitory computer-readable medium storing a set of instructions for wireless communication, the set of instructions comprising one or more instructions that, when executed by one or more processors of a device, cause the device to perform the method of one or more of Aspects 36-58.

Aspect 78: A device for wireless communication, the device comprising a processing system that includes one or more processors and one or more memories coupled with the one or more processors, the processing system configured to cause the device to perform the method of one or more of Aspects 36-58.

Aspect 79: An apparatus for wireless communication at a device, the apparatus comprising one or more memories and one or more processors coupled to the one or more memories, the one or more processors individually or collectively configured to cause the device to perform the method of one or more of Aspects 36-58.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus configured for wireless communications, comprising:
one or more memories comprising processor-executable instructions; and
one or more processors configured to execute the processor-executable instructions and cause the apparatus to:
transmit an early data transmission (EDT) communication; and
receive a response communication that indicates:
a successful content resolution of the EDT communication, and
a UE-specific cell radio network temporary identifier (C-RNTI).

2. The apparatus of claim 1, wherein the one or more processors are configured to cause the apparatus to:
communicate in a wireless network using the UE-specific C-RNTI based at least in part on the successful content resolution of the EDT communication.

3. The apparatus of claim 1, wherein the response communication is addressed to a multicast C-RNTI, and
wherein the multicast C-RNTI comprises:
a temporary C-RNTI,
a configured RNTI, or
an RNTI derived from the uplink transmission occasion of EDT.

4. The apparatus of claim 3, wherein the one or more processors are configured to cause the apparatus to:
discard, based at least in part on the response communication indicating the successful content resolution of the EDT communication, use of the multicast C-RNTI for physical downlink control channel (PDCCH) monitoring.

5. The apparatus of claim 1, wherein the one or more processors, to cause the apparatus to transmit the EDT communication, are configured to cause the apparatus to:
transmit the EDT communication as part of a random access channel (RACH) procedure, and
wherein the one or more processors, to cause the apparatus to receive the response communication, are configured to cause the apparatus to:
receive the response communication as at least part of the RACH procedure.

6. The apparatus of claim 1, wherein the response communication indicates the UE-specific C-RNTI in:
a radio resource control (RRC) communication,
a medium access control (MAC) control element (CE), or
downlink control information (DCI).

7. The apparatus of claim 1, wherein the indication of the UE-specific C-RNTI is an absolute C-RNTI.

8. The apparatus of claim 1, wherein the indication of the UE-specific C-RNTI is a delta C-RNTI that is based at least in part on a multicast C-RNTI used to address the response communication.

9. The apparatus of claim 1, wherein the one or more processors are configured to cause the apparatus to:
transmit a capability indication that specifies support for a UE-specific C-RNTI assignment for EDT.

10. An apparatus configured for wireless communications, comprising:
one or more memories comprising processor-executable instructions; and
one or more processors configured to execute the processor-executable instructions and cause the apparatus to:
transmit an early data transmission (EDT) communication; and
receive a response communication that is addressed to a multicast cell radio network temporary identifier (C-RNTI), the multicast C-RNTI comprising:
a temporary C-RNTI,
a configured RNTI, or
an RNTI derived from the uplink transmission occasion of EDT, the response communication indicating:
an unsuccessful content resolution of the EDT communication, and
an indication to continue monitoring a downlink communication channel using the multicast C-RNTI.

11. The apparatus of claim 10, wherein the response communication comprises a retransmission grant for the EDT communication, and
wherein the one or more processors are configured to cause the apparatus to:
retransmit the EDT communication using the retransmission grant and without performing a content resolution failure procedure.

12. The apparatus of claim 10, wherein the EDT communication includes a content resolution identifier (ID) linked to a user equipment (UE) that is associated with the apparatus, and
wherein the response communication that indicates the unsuccessful contention resolution does not include the content resolution ID that is linked to the UE.

13. The apparatus of claim 10, wherein the one or more processors, to cause the apparatus to transmit the EDT communication, are configured to cause the apparatus to:
transmit the EDT communication as part of a random access channel (RACH) procedure, and
wherein the one or more processors, to cause the apparatus to receive the response communication, are configured to cause the apparatus to:
receive the response communication as at least part of the RACH procedure.

14. The apparatus of claim 10, wherein the one or more processors, to cause the apparatus to receive the response communication that indicates the unsuccessful content resolution of the EDT communication, are configured to cause the apparatus to:
receive a physical uplink shared channel (PUSCH) resource collision indicator that specifies that the EDT communication is associated with the unsuccessful content resolution.

15. An apparatus configured for wireless communications, comprising:
one or more memories comprising processor-executable instructions; and
one or more processors, configured to execute the processor-executable instructions and cause the apparatus to:
receive a first early data transmission (EDT) communication from a first user equipment (UE) and a second EDT communication from a second UE; and
transmit, based at least in part on decoding the first EDT, a first response communication that is directed to the first UE and indicates:
a successful content resolution of the first EDT communication, and
a UE-specific C-RNTI that is assigned to the first UE.

16. The apparatus of claim 15, wherein the one or more processors are configured to cause the apparatus to:
communicate in a wireless network with the first UE using the UE-specific C-RNTI and based at least in part on the successful content resolution of the EDT communication.

17. The apparatus of claim 15, wherein the first response communication is addressed to a multicast C-RNTI.

18. The apparatus of claim 15, wherein the one or more processors, to cause the apparatus to receive the first EDT communication, are configured to cause the apparatus to:
receive the first EDT communication as part of a random access channel (RACH) procedure, and
wherein the one or more processors, to cause the apparatus to transmit the first response communication, are configured to cause the apparatus to:
transmit the first response communication as at least part of the RACH procedure.

19. The apparatus of claim 15, wherein the one or more processors are configured to cause the apparatus to:
transmit, based at least in part on failing to decode the second EDT communication, a second response communication that is addressed to a multicast C-RNTI and indicates:
an unsuccessful content resolution of the second EDT communication, and
an indication to continue monitoring a physical downlink control channel (PDCCH) using the multicast C-RNTI.

20. The apparatus of claim 19, wherein the second response communication comprises a retransmission grant for the EDT communication.
